(19) United States
(12) Patent Application Publication
(10) Pub. No.: US 2016/0034645 A1
(43) Pub. Date: Feb. 4, 2016

(54) INTERPRETATION REQUEST MANAGEMENT SYSTEM, METHOD FOR CONTROLLING THE SAME, INTERPRETATION REQUEST MANAGEMENT APPARATUS, METHOD FOR CONTROLLING THE SAME, AND NON-TRANSITORY COMPUTER-READABLE MEDIUM

(71) Applicant: CANON KABUSHIKI KAISHA, Tokyo (JP)

(72) Inventors: Kazuki Takahashi, Yokohama-shi (JP); Noriaki Sakai, Funabashi-shi (JP)

(21) Appl. No.: 14/808,379

(22) Filed: Jul. 24, 2015

(30) Foreign Application Priority Data
Aug. 1, 2014 (JP) 2014-158227
Apr. 24, 2015 (JP) 2015-089750

(51) Int. Cl. G06F 19/00

(52) U.S. Cl. CPC G06F 19/322

(57) ABSTRACT

An interpretation request management system for managing interpretation requests for interpreting medical image data sets, comprises: a management unit that manages the interpretation requests together with attribute information sets indicating attributes of medical image data sets; a receiving unit that receives parameters corresponding to a plurality of interpretation doctors with respect to each of the attribute information sets, the parameters indicating degrees used for determining assignees to which the interpretation requests are assigned; and an assignee determination unit that determines an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors.

### BACKGROUND OF THE INVENTION

1. Field of the Invention

The present invention relates to an interpretation request management system, a method for controlling the same, an interpretation request management apparatus, a method for controlling the same, and a non-transitory computer-readable medium, and in particular to a technology for assigning an image to be interpreted to an interpretation doctor who interprets medical images.

2. Description of the Related Art

Conventionally, medical image apparatuses such as apparatuses for CT (Computed Tomography) and MRI (Magnetic Resonance Imaging) are used for capturing images of patients, and an interpretation (reading) is made of medical images obtained by image capturing. For interpretation of a medical image, a person engaged in the operations for arranging assignments (hereinafter, “clerk”) assigns a request for interpretation to an interpretation doctor (or interpreter, reader), taking into account each interpretation doctor's area of expertise and schedule. In other words, the clerk manually assigns a request for interpretation based on his/her own experience, and this is troublesome for the clerk. Also, if the clerk does not have sufficient experience, requests for interpretation are assigned to the interpretation doctors unequally, and the workload on the interpretation doctors cannot be appropriately distributed.

Japanese Patent Laid-open No. 2002-329190 discloses a mechanism for: managing the received schedule information of a plurality of doctors; receiving medical images from a remote location; automatically assigning the medical images to the doctors according to the schedule information; and delivering the medical images to the doctors via a communication network.

However, according to Japanese Patent Laid-open No. 2002-329190, only the interpretation doctors' schedule is taken into account when automatically assigning the requests for interpretation, and the expertness of the interpretation doctors (the specific area of expertise based on the examination type, the body part, etc.) and the degree of proficiency are not taken into account. Therefore, if a medical image assigned to a doctor is not exactly within the specific area of expertise of the doctor even though the doctor can interpret the medical image, the problem of the doctor taking a long time to make an interpretation may occur.

### SUMMARY OF THE INVENTION

The present invention provides a mechanism for determining the assignees to which interpretation requests are assigned, taking into account parameters that indicate degrees used for determining the assignees to which interpretation requests are assigned and that are provided for each attribute information set included in the interpretation requests and corresponding to each of a plurality of interpretation doctors.

According to one aspect of the present invention, there is provided an interpretation request management system for managing interpretation requests for interpreting medical image data sets, comprising: a management unit configured to manage the interpretation requests together with attribute information sets indicating attributes of medical image data sets; a receiving unit configured to receive parameters corresponding to a plurality of interpretation doctors with respect to each of the attribute information sets, the parameters indicating degrees used for determining assignees to which the interpretation requests are assigned; and an assignee determination unit configured to determine an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors.

According to another aspect of the present invention, there is provided a method for controlling an interpretation request management system for managing interpretation requests for interpreting medical image data sets, comprising: a management step of managing the interpretation requests together with attribute information sets indicating attributes of medical image data sets; a receiving step of receiving parameters corresponding to a plurality of interpretation doctors, with respect to each of the attribute information sets, the parameters indicating degrees used for determining assignees to which the interpretation requests are assigned; and an assignee determination step of determining an interpretation doctor to be assigned an interpretation request having an attribute indicated by a corresponding attribute information set, based on the degrees indicated by the parameters that are received in the receiving step, that correspond to the attribute information sets of the interpretation requests managed in the management step, and that correspond to the plurality of interpretation doctors.

According to another aspect of the present invention, there is provided a non-transitory computer-readable medium storing therein a program to be executed by an interpretation request management system for managing interpretation requests for interpreting medical image data sets, the program causing the interpretation request management system to function as: a management unit configured to manage the interpretation requests together with attribute information sets indicating attributes of medical image data sets; a receiving unit configured to receive parameters corresponding to a plurality of interpretation doctors, with respect to each of the attribute information sets, the parameters indicating degrees used for determining assignees to which the interpretation requests are assigned; and an assignee determination unit configured to determine an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors.

According to another aspect of the present invention, there is provided an interpretation request management apparatus for managing interpretation requests for interpreting medical image data sets, comprising: a management unit configured to manage the interpretation requests together with attribute information sets indicating attributes of medical image data sets; a receiving unit configured to receive parameters corresponding to a plurality of interpretation doctors, with respect to each of the attribute information sets, the parameters indicating degrees used for determining assignees to which the interpretation requests are assigned; and an assignee determination unit configured to determine an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors.

According to another aspect of the present invention, there is provided a method for controlling an interpretation request management apparatus for managing interpretation requests for interpreting medical image data sets, comprising: a management step of managing the interpretation requests together with attribute information sets indicating attributes of medical image data sets; a receiving step of receiving parameters corresponding to a plurality of interpretation doctors, with respect to each of the attribute information sets, the parameters indicating degrees used for determining assignees to which the interpretation requests are assigned; and an assignee determination step of determining an interpretation doctor to be assigned an interpretation request having an attribute indicated by a corresponding attribute information set, based on the degrees indicated by the parameters that are received in the receiving step, that correspond to the attribute information sets of the interpretation requests managed in the management step, and that correspond to the plurality of interpretation doctors.

According to another aspect of the present invention, there is provided a non-transitory computer-readable medium storing therein a program to be executed by an interpretation request management apparatus for managing interpretation requests for interpreting medical image data sets, the program causing the interpretation request management apparatus to function as: a management unit configured to manage the interpretation requests together with attribute information sets indicating attributes of medical image data sets; a receiving unit configured to receive parameters corresponding to a plurality of interpretation doctors, with respect to each of the attribute information sets, the parameters indicating degrees used for determining assignees to which the interpretation requests are assigned; and an assignee determination unit configured to determine an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors.

The present invention allows for determining the assignees to which interpretation requests are assigned, taking into account parameters that indicate degrees used for determining the assignees to which interpretation requests are assigned and that are provided for each attribute information set included in the interpretation requests and corresponding to each of a plurality of interpretation doctors.

Further features of the present invention will become apparent from the following description of exemplary embodiments (with reference to the attached drawings).

### BRIEF DESCRIPTION OF THE DRAWINGS

FIG. 1 is a diagram showing an example of a system configuration according to an embodiment.

FIG. 2 is a diagram showing an example of a hardware configuration of an information processing apparatus according to the embodiment.

FIG. 3 is a diagram showing an example of a functional configuration of a remote interpretation server according to the embodiment.

FIG. 4 is a flowchart for the entire processing.

FIG. 5 is a flowchart for a request application process.

FIG. 6 is a flowchart for an assignment characteristics initial value setting process.

FIG. 7 is a flowchart for a request acceptance process.

FIG. 8 is a flowchart for a request assignment process.

FIGS. 9A, 9B, and 9C are flowcharts for an automated assignment process.

FIG. 10 is a diagram showing an example of a requestor facility work list screen.

FIG. 11 is a diagram showing an example of a request application screen.

FIG. 12 is a diagram showing an example of an interpretation center work list screen.

FIG. 13 is a diagram showing an example of a request acceptance screen.

FIG. 14 is a diagram showing an example of an expertness setting screen.

FIG. 15 is a diagram showing an example of an assignment screen.

FIG. 16 is a diagram showing an example of automated assignment results displayed on the assignment screen.

FIG. 17 is a diagram showing an example of a configuration of an examination type table.

FIG. 18 is a diagram showing an example of a configuration of a body part table.

FIG. 19 is a diagram showing an example of a configuration of a classification table.

FIG. 20 is a diagram showing an example of a configuration of an assignment characteristics master table.

FIG. 21 is a diagram showing an example of a configuration of a count score addition table.

FIG. 22 is a diagram showing an example of a configuration of a score setting table.

FIG. 23 is a diagram showing an example of a configuration of an assignment characteristics mapping table.

FIGS. 24A and 24B are diagrams showing examples of a configuration of an expertness table.

FIG. 25 is a diagram showing an example of a configuration of an interpretation doctor elimination table.

FIGS. 26A and 26B are diagrams showing examples of a configuration of an interpretation doctor schedule table.

FIG. 27 is a diagram showing an example of a configuration of a request information table.

FIG. 28 is a diagram showing the state of the request information table after sorting.

FIG. 29 is a diagram showing the state of the request information table after assignment.

FIG. 30 is a diagram showing automated assignment determination results.

FIG. 31 is a diagram showing a conceptual illustration of an interpretation doctor schedule after automated assignment.

FIG. 32 is a flowchart for a request assignment process according to a second embodiment.

FIG. 33A is a flowchart for an automated assignment process according to a second embodiment.

FIG. 33B is a flowchart for an automated assignment process according to the second embodiment.

FIG. 33C is a flowchart for an automated assignment process according to a second embodiment.

FIG. 33D is a flowchart for an automated assignment process according to a second embodiment.

FIG. 34 is a diagram showing an example of an assignment condition setting screen.

FIG. 35 is a diagram showing an example of an interruption facility information table.

### DESCRIPTION OF THE EMBODIMENTS

### First Embodiment

The following provides a detailed description of an embodiment of the present invention with reference to the drawings. Note that the configurations shown below are merely examples, and the present invention is not limited to the examples.

System Configuration

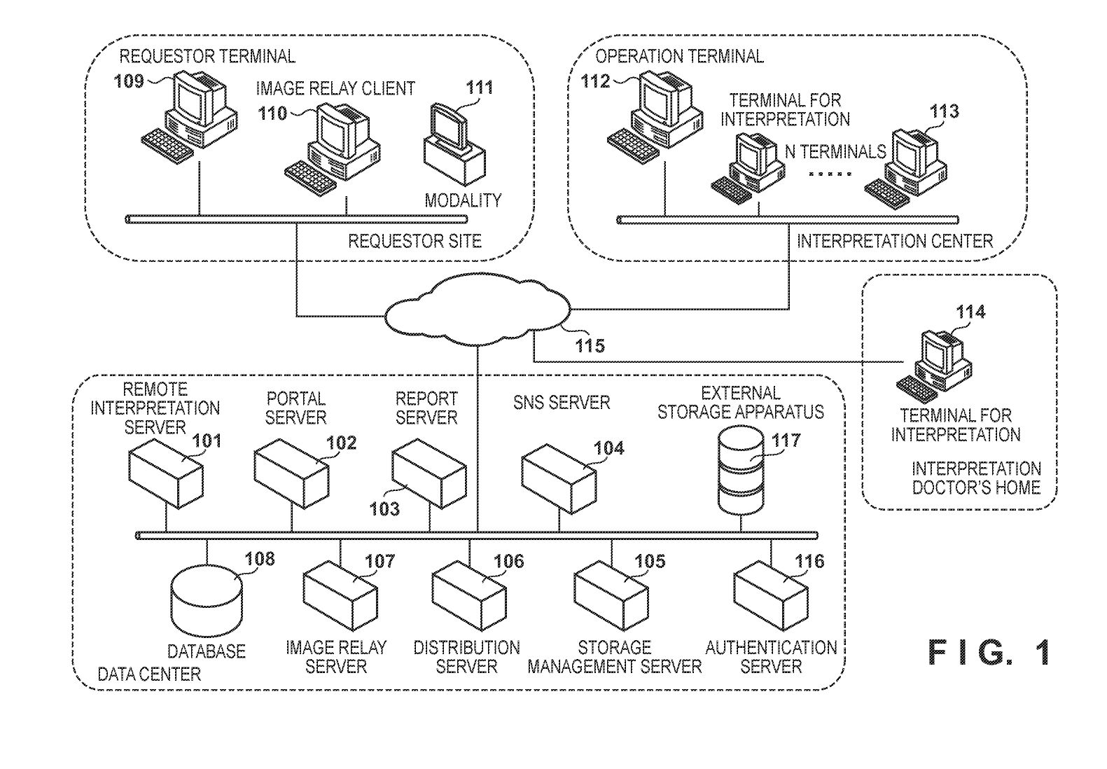

FIG. 1 shows an example of an overall configuration of a remote interpretation system as an information processing system according to the embodiment. In the present embodiment, a data center, a requestor facility, an interpretation center, and an interpretation doctor's home are included in the remote interpretation system as locations concerned, and the locations are communicatively connected by a network 115.

At the beginning of the access to the remote interpretation system from PCs (109, 112, 113, 114) serving as client terminals provided in the locations, each user of the remote interpretation system is subjected to authentication performed with use of an authentication function provided by an authentication server 116. After successful authentication, a portal screen (not shown in the drawings) provided by a portal server 102 is presented to the user. Also, the user can exchange messages with another user by using an SNS server 104.

Image data (medical image data) to be used in remote interpretation is captured by a modality 111 that is an image capturing apparatus at the requestor facility, and the image data is then transmitted to an image relay client 110. This image data is, for example, image data in the DICOM (Digital Imaging and COmmunication in Medicine) format. The image relay client 110 archives the image data transmitted from the modality 111, and then transmits it to an image relay server 107 provided in the data center. The image relay server 107 processes the image data transmitted from the requestor facility, and transmits it to a storage management server 105. The storage management server 105 issues a unique ID (identification information) to each image data set, and stores the IDs into an external storage apparatus 117. The person in charge of the interpretation requesting operation at the requestor facility inputs information (request information) necessary for making an interpretation request by using the requestor terminal 109, and the request information is transmitted to the data center together with the image data. Each request information set is stored in a database 108 at the data center. Note that in the present Specification, the request information sets correspond to the image data sets, and the assignment (sorting) of the request information sets are treated as the assignment of the image data sets.

The interpretation doctor, who conducts an image interpretation, downloads and refers to the interpretation image data set that corresponds to the assigned interpretation request, from a distribution server 106, by using the terminal 113 for interpretation, provided in the interpretation center (or the terminal 114 for interpretation provided at home), and then makes an interpretation of the image data set. After that, the interpretation doctor composes a report on the interpretation results by using an application program (not shown in the drawings) running on the terminal 113 for interpretation. The report thus composed is transmitted to a report server 103, and is then stored in the database 108. Note that although the terminals for interpretation in the example above are provided in the interpretation center and the interpretation doctor's home, they may be provided in any location, and the system may be configured such that the image data sets can be referred to by using a mobile terminal or the like.

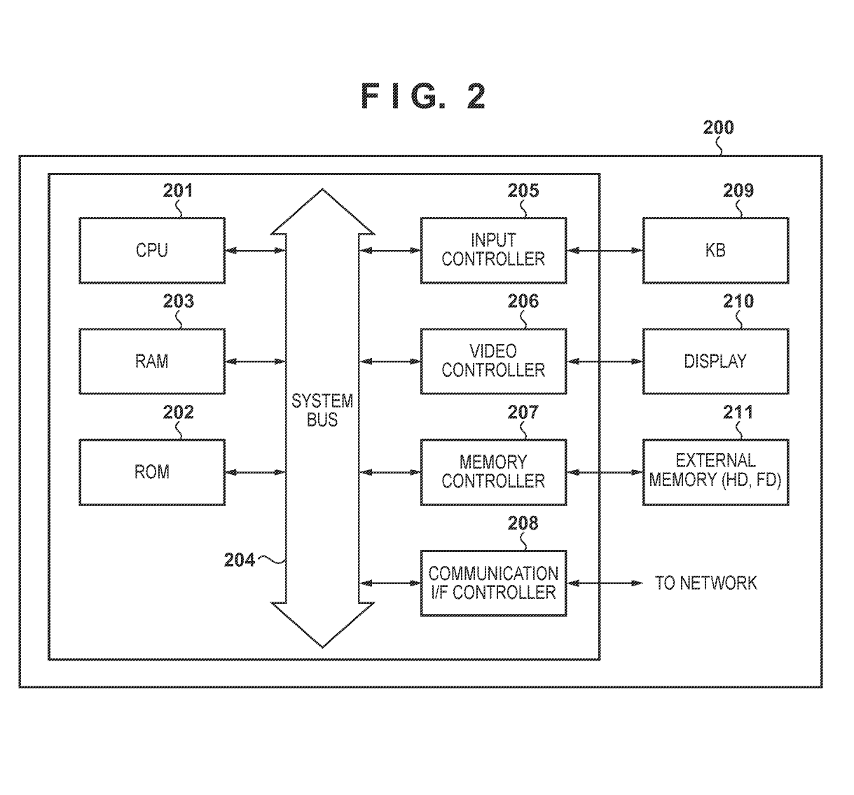

FIG. 2 is a diagram showing an example of the hardware configuration of an information processing apparatus, and examples of the apparatus include various kinds of servers and terminals. A CPU 201 takes overall control of the devices and the controllers connected to a system bus 204. A ROM 202 or an external memory 211 stores, for example, a BIOS (Basic Input/Output System), an operating system (OS), and various kinds of programs and the like for achieving the functions of each terminal.

A RAM 203 serves as, for example, a main memory and work area of the CPU 201. The CPU 201 loads, for example, programs required for execution of processes, from the ROM 202 or the external memory 211 to the RAM 203, and achieves various kinds of operations by executing the programs. An input controller 205 controls the input from a keyboard (KB) 209 and a pointing device (not shown in the drawings) such as a mouse. A video controller 206 performs display control for a display 210 such as a CRT display.

A memory controller 207 controls access to the external memory 211 storing various kinds of data and so on. Examples of the external memory 211 include an external storage apparatus (HD), a flexible disk (FD), and a compact Flash™ memory to be connected to a PCMCIA card slot via an adapter. A communication I/F controller 208 connects to, and performs communication control of, an external device, via a network (e.g. the network 115 shown in FIG. 1). The communication I/F controller 208 is capable of performing, for example, communications using TCP/IP.

The various kinds of programs for implementing the present invention are stored in the external memory 211, and are loaded to the RAM 203 and executed by the CPU 201 as needed. Furthermore, definition files and various kinds of information tables, for example, are also stored in the external memory 211, which will be described later in detail.

Functional Configuration

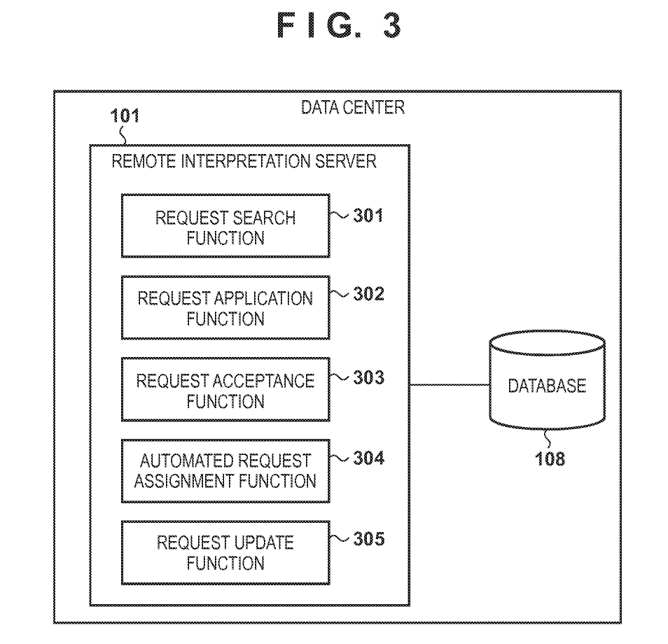

FIG. 3 is a diagram showing an example of the functional configuration of a remote interpretation server 101 according to the present embodiment.

Upon receiving a request for the data required for displaying a request application screen, etc. from the requestor terminal 109 located in the requestor facility, the remote interpretation server 101 analyzes the request by using a request search function 301. Then, the remote interpretation server 101 searches a request information table 2700 contained in the database 108, and returns display information (e.g. a Web page) to the requestor terminal 109. In other words, the request search function 301 is a functional unit that executes Steps S202 and S402 of the process described below. Upon receiving a request for request application from the requestor terminal 109, the remote interpretation server 101 analyzes the request by using a request application function 302, and updates the request information table 2700 contained in the database 108. In other words, the request application function 302 is a functional unit that executes Step S101 of the process described below.

Upon receiving a request for request acceptance from the requestor terminal 109, the remote interpretation server 101 analyzes the request by using a request acceptance function 303, and updates the request information table 2700 contained in the database 108. In other words, the request acceptance function 303 is a functional unit that executes Step S102 of the process described below. Upon receiving a request for automated request assignment from the requestor terminal 109, the remote interpretation server 101 executes an automated request assignment function 304. In other words, the remote interpretation server 101 reads data sets contained in the database 108, such as the request information table 2700, an expertness table 2400, and an interpretation doctor schedule table 2600, and performs automated assignment. After that, the remote interpretation server 101 returns the processing results to the requestor terminal 109. In other words, the automated request assignment function 304 is a functional unit that executes Step S103 of the process described below. Upon receiving a request for assignment result saving from the requestor terminal 109, the remote interpretation server 101 analyzes the request by using a request update function 305, and updates the request information table 2700 contained in the database 108.

Processes

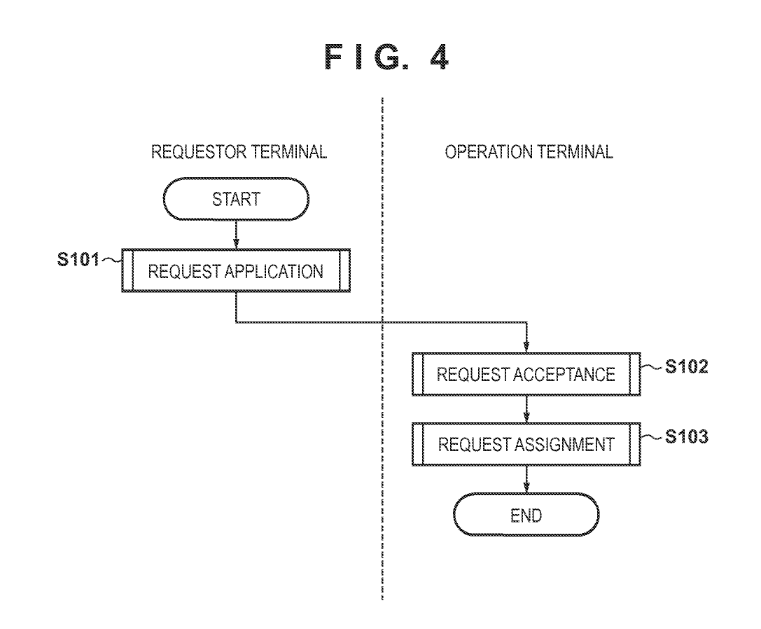

FIG. 4 is a flowchart for the entire processing according to the present embodiment. Although the flowchart shows only the requestor terminal 109 that originates the processing and the operation terminal 112, it is assumed here that each terminal cooperates with the remote interpretation server 101 in each process. Also, it is assumed in the present embodiment that the requestor terminal 109 and the operation terminal 112 do not exchange data directly with each other.

Furthermore, it is assumed in the present embodiment that, as described above, the image data sets captured in advance by the modality 111 at the requestor facility have been timely transmitted to the data center and have been registered to the external storage apparatus 117. Accordingly, the respective sets of information about the interpretation requests (request information sets) corresponding to the image data sets are registered to the database 108 in groups, for example, by patient, by date, and by examination type. Also, it is assumed that one or more image data sets are associated with one request information set. Note that it is assumed that, at the time of registration, no application has been made for assigning the requests, and the requests with the status indicating that no application has been made are managed in the database 108.

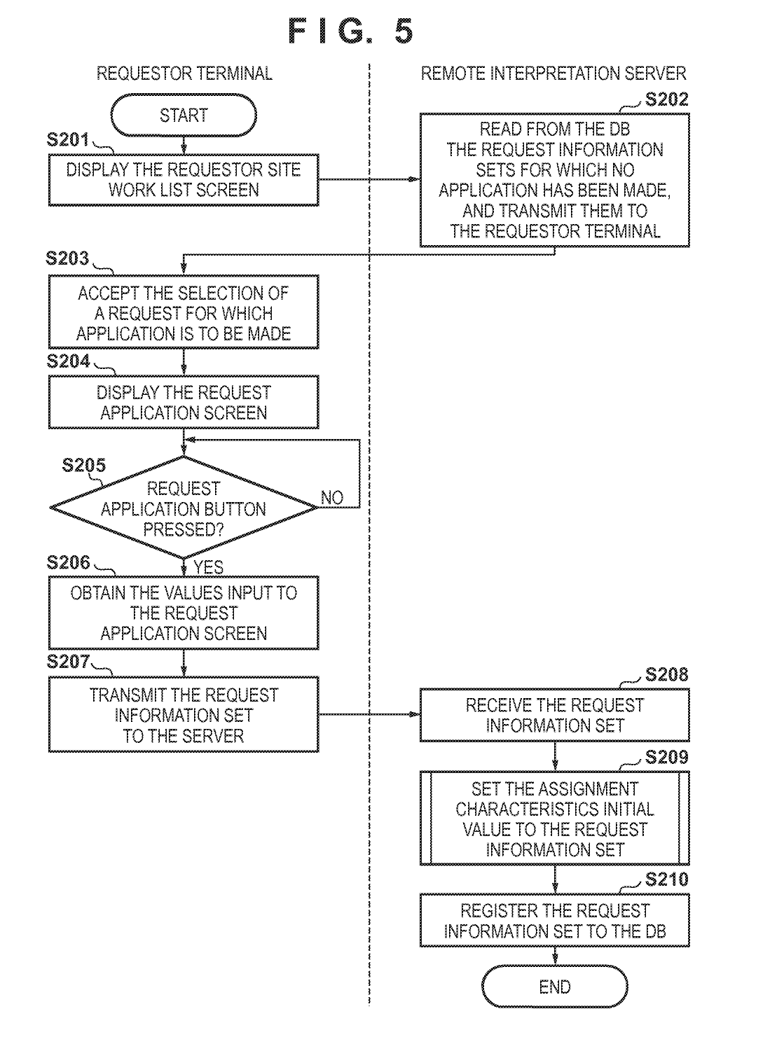

In Step S101, the requestor terminal 109 executes a request application process, which is shown in FIG. 5, according to a user instruction. The details of the request application process are described below with reference to FIG. 5.

In Step S102, the operation terminal 112 executes a request acceptance process, which is shown in FIG. 7, according to a user instruction. The details of the request acceptance process are described below with reference to FIG. 7.

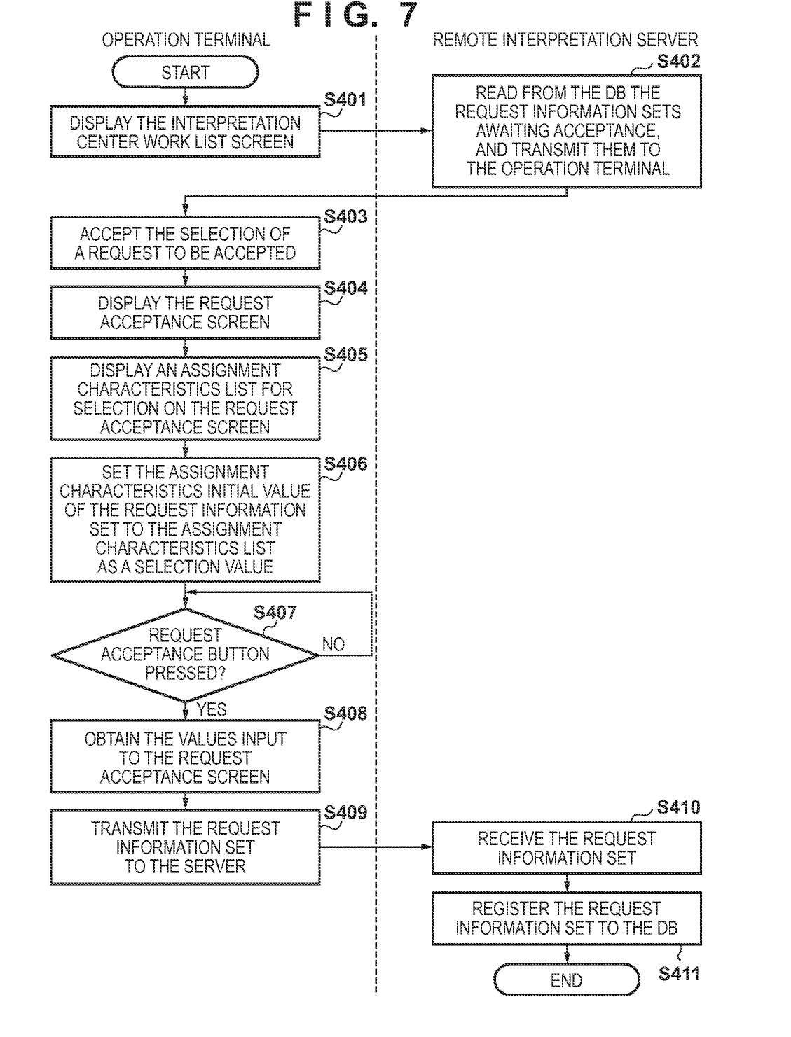

In Step S103, the operation terminal 112 executes a request assignment process, which is shown in FIG. 8, according to a user instruction. The details of the request assignment process are described below with reference to FIG. 8.

Request Application Process

FIG. 5 is a flowchart for the request application process executed by the requestor terminal 109 and the remote interpretation server 101 cooperating with each other. The following processing steps are achieved by the respective CPUs of the requestor terminal 109 and the remote interpretation server 101, reading out and executing the programs stored in each storing unit.

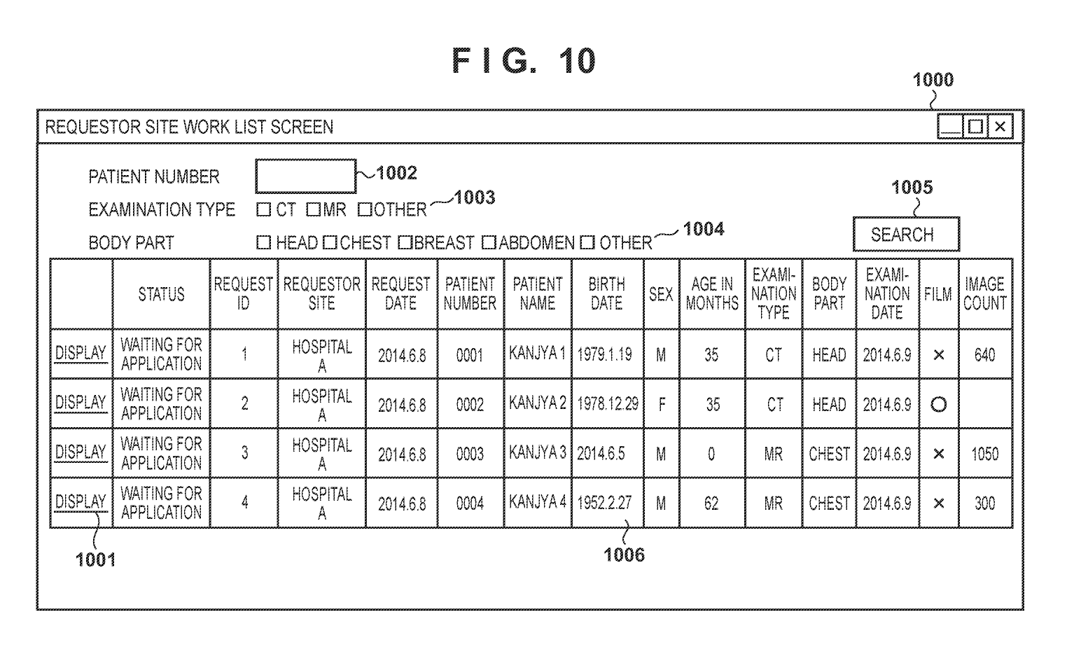

In Step S201, the requestor terminal 109 displays a requestor facility work list screen 1000, which is shown in FIG. 10, according to a user instruction. The requestor terminal 109 may display the screen by using a Web browser (not shown in the drawings) that the requestor terminal 109 is provided with, or display the screen with the aid of a predetermined application program. In order to obtain the request information sets to be displayed on the requestor facility work list screen 1000, the requestor terminal 109 provides the remote interpretation server 101 with an instruction to obtain the request information sets that have the status indicating that no application has been made. Note that the details of the statuses of the request information sets are described below along with the details of the tables.

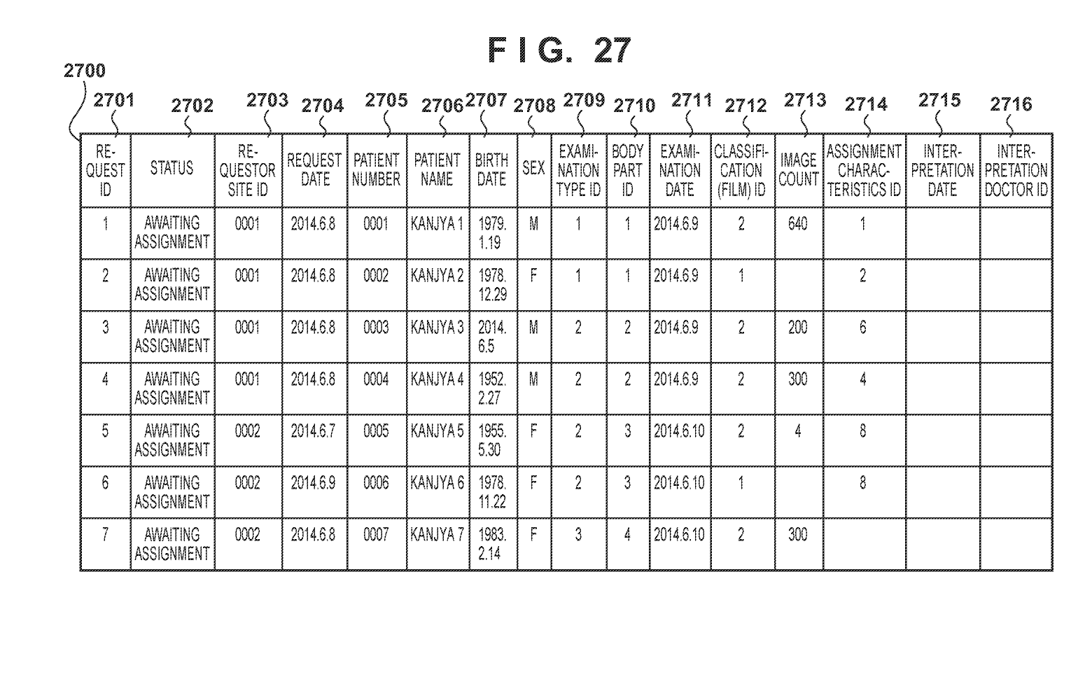

In Step S202, in response to an instruction from the requestor terminal 109, the remote interpretation server 101 returns to the requestor terminal 109 the request information sets that have the status indicating that no application has been made, selected from among the request information sets shown in FIG. 27. Specifically, in the request information table 2700 shown in FIG. 27, the request information sets whose value of a status 2702 is “Awaiting application” are returned to the requestor terminal 109. Then, the requestor terminal 109 displays the received request information sets on the requestor facility work list screen 1000.

In Step S203, the requestor terminal 109 accepts the selection of a request for which an application is to be made, from the user, via the requestor facility work list screen 1000. Specifically, the requestor terminal 109 receives the designation of a display button 1001 on the requestor facility work list screen 1000, thereby receiving the selection of a request for which an application is to be made. The requestor terminal 109 obtains a request ID 2701 of the selected request for which an application is to be made.

In Step S204, the requestor terminal 109 displays a request application screen 1100, which is shown in FIG. 11, in order to display the request information set corresponding to the request ID 2701 obtained in Step S203. The request application screen 1100 is used for inputting, for example, information about the patient and information required for interpretation (e.g. symptoms of the patient). Note that the information may be manually input by the requestor, or automatically input according to the input of the identification information such as a patient number 1103, and also a file to be attached may be specified.

In Step S205, the requestor terminal 109 determines whether or not a request application button 1113 on the request application screen 1100 has been pressed. When the request application button 1113 has been pressed (YES in Step S205), the process advances to Step S206.

In Step S206, the requestor terminal 109 obtains the request information set containing the examination type 1109, a body part 1110, etc. input to the request application screen 1100.

In Step S207, the requestor terminal 109 transmits the request information set obtained in Step S206, to the remote interpretation server 101.

In Step S208, the remote interpretation server 101 receives the request information set transmitted from the requestor terminal 109.

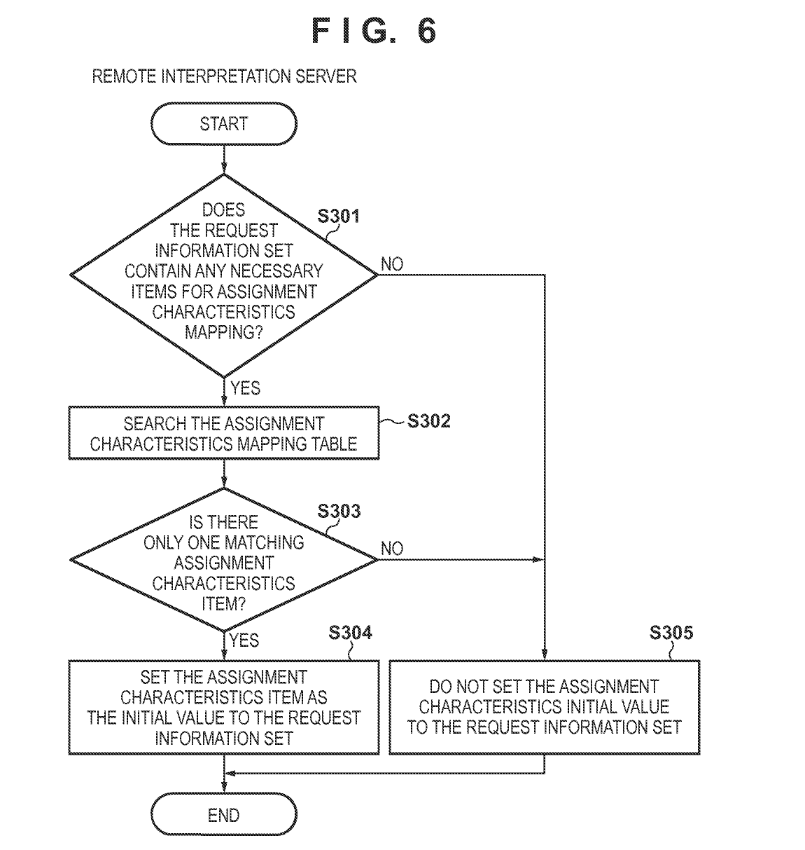

In Step S209, the remote interpretation server 101 sets the assignment characteristics initial value, based on the request information set received in Step S208. The details of this process are described below with reference to FIG. 6.

In Step S210, the remote interpretation server 101 adds the assignment characteristics initial value, which has been set in Step S209, to the request information set received in Step S208, and stores the request information set to the database 108. At this moment, the value of the status 2702, which indicates the status of the request information set, is changed to “Awaiting acceptance”. Then, this process ends.

Assignment Characteristics Initial Value Setting Process

FIG. 6 is a flowchart showing the process, executed by the remote interpretation server 101, of setting an assignment characteristics initial value to a request information set for which an application has been made. This process corresponds to Step S209 of FIG. 5. In the present embodiment, information referred to as “assignment characteristics” is used as information for assigning the interpretation data sets to the interpretation doctors. A specific description of the configuration of the assignment characteristics is provided below along with a description of the process.

In Step S301, the remote interpretation server 101 determines whether or not the request information set received from the requestor terminal 109 contains necessary information for a mapping process, which is to be executed for determining the assignment characteristics initial value. It is assumed that the necessary information here is the examination type, the body part, the class, the patient's age, and the patient's sex. When it is determined that the necessary information is contained (YES in Step S301), the remote interpretation server 101 determines that it is possible to set the assignment characteristics initial value, and the process advances to Step S302. On the other hand, when it is determined that the necessary information is not contained (NO in Step S301), the remote interpretation server 101 determines that it is impossible to set the assignment characteristics initial value, and the process advances to Step S305.

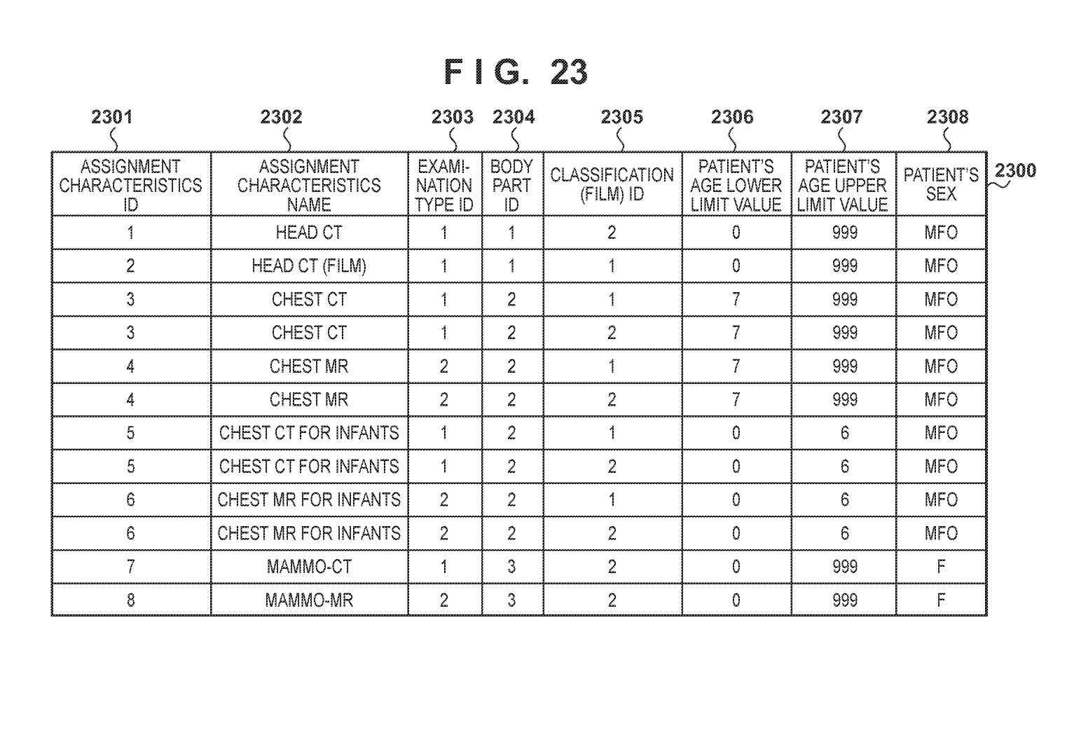

In Step S302, the remote interpretation server 101 searches for assignment characteristics IDs 2301 in an assignment characteristics mapping table 2300 stored in the database 108, which is shown in FIG. 23, by using, as the condition values (keys), the values of all of the examination type, the body part, the classification, the patient's age, and the patient's sex. Note that the patient's age may be calculated from the examination date and the patient's birth date contained in the request information set.

In Step S303, the remote interpretation server 101 determines whether the number of the assignment characteristics ID(s) 2301 detected in Step S302 is 1 or not. When the number is 1 (YES in Step S303), the remote interpretation server 101 determines that the assignment characteristics mapping has resulted in success, and the process advances to Step S304. When the number is 0, or 2 or more (NO in Step S303), the remote interpretation server 101 determines that the assignment characteristics mapping has resulted in failure, and the process advances to Step S305.

In Step S304, the remote interpretation server 101 sets the single assignment characteristics ID 2301 found in Step S303 to the request information set, as the initial value. Then, this process ends.

In Step S305, the remote interpretation server 101 does not set the assignment characteristics ID 2301 to the request information set, and the process ends.

Request Acceptance Process

FIG. 7 is a flowchart for the request acceptance process executed by the operation terminal 112 and the remote interpretation server 101 cooperating with each other. The following processing steps are achieved by the respective CPUs of the operation terminal 112 and the remote interpretation server 101, reading out and executing the programs stored in each storing unit.

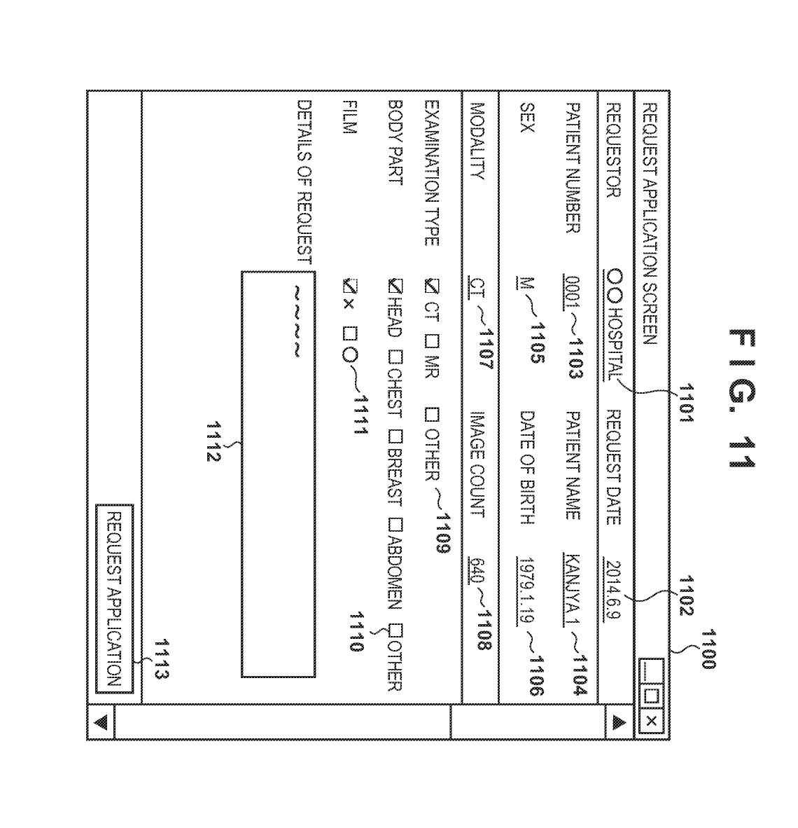

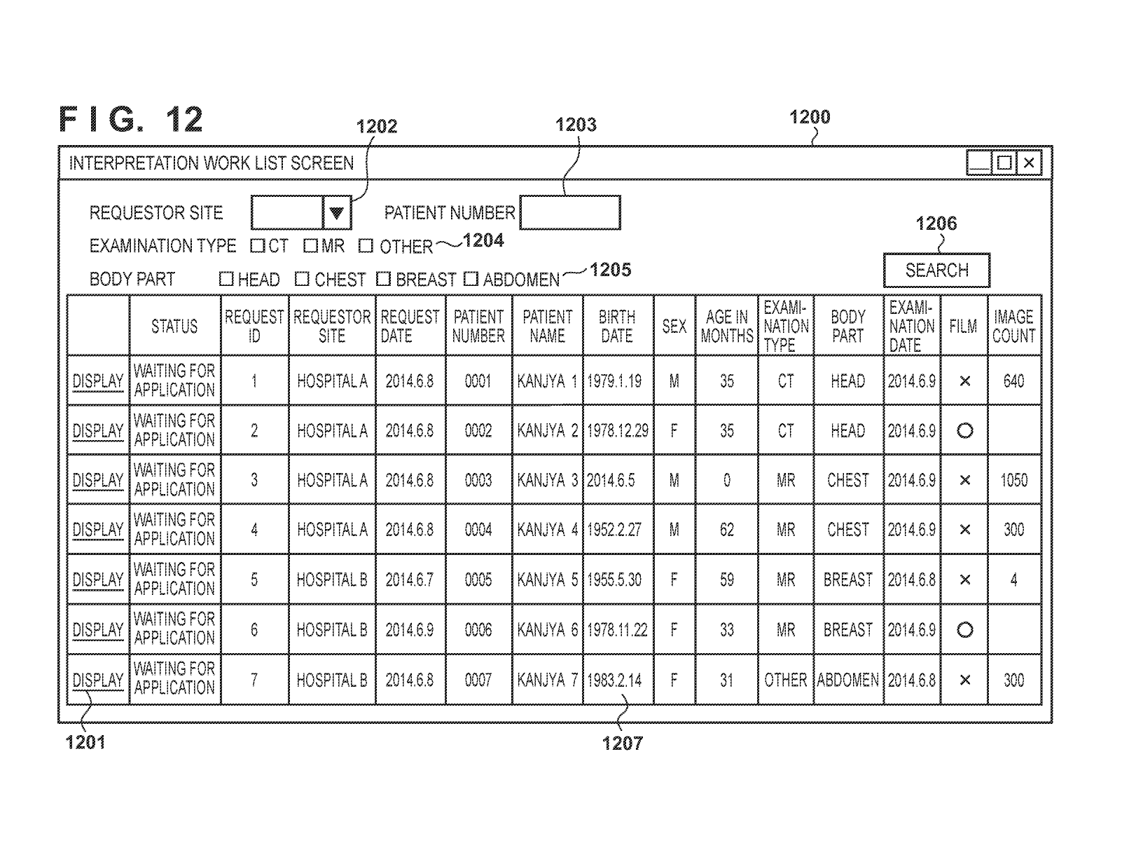

In Step S401, the operation terminal 112 displays an interpretation center work list screen 1200, which is shown in FIG. 12, according to a user instruction. The operation terminal 112 may display the screen by using a Web browser (not shown in the drawings) that the operation terminal 112 is provided with, or display the screen with the aid of a predetermined application program. In order to obtain the request information sets to be displayed on the interpretation center work list screen 1200, the operation terminal 112 provides the remote interpretation server 101 with an instruction to obtain the request information sets that have the status indicating that the acceptance of the request is awaited.

In Step S402, in response to an instruction from the operation terminal 112, the remote interpretation server 101 returns to the operation terminal 112 the request information sets that have the status indicating that the acceptance of the request is awaited, selected from among the request information sets shown in FIG. 27. Specifically, in the request information table 2700, the request information sets whose value of the status 2702 is “Awaiting acceptance” are returned to the operation terminal 112. Then, the operation terminal 112 displays the received request information sets on the interpretation center work list screen 1200.

In Step S403, the operation terminal 112 accepts the selection of a request to be accepted, from the user, via the interpretation center work list screen 1200. Specifically, the operation terminal 112 receives the designation of a display button 1201 on the interpretation center work list screen 1200, thereby receiving the selection of a request to be accepted. The operation terminal 112 obtains the request ID 2701 of the selected request that is to be accepted.

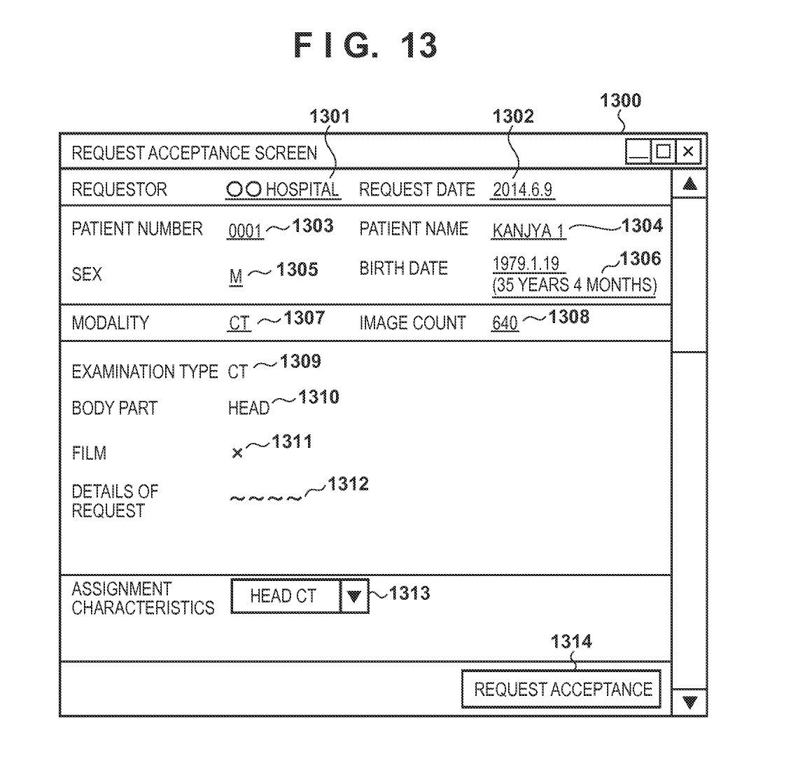

In Step S404, the operation terminal 112 displays a request acceptance screen 1300, which is shown in FIG. 13, in order to display the request information set corresponding to the request ID obtained in Step S403. The request acceptance screen 1300 displays various kinds of information that are input at the time when the request application is made.

In Step S405, the operation terminal 112 displays an assignment characteristics selection list 1313 on the request acceptance screen 1300.

In Step S406, the operation terminal 112 sets, as a selection value, the assignment characteristics initial value, which is set by the process shown in FIG. 6, onto the assignment characteristics selection list 1313 of the request acceptance screen 1300. As a result, the user can use the assignment characteristics item that has been set from the operation terminal 112 as the initial value, without performing any setting operation. Note that when no initial value is set by the process shown in FIG. 6, information showing that selection from the list is required may be displayed. Also, even when the assignment characteristics initial value has been set, it is possible to change the value by receiving a selection from the list.

In Step S407, the operation terminal 112 determines whether or not a request acceptance button 1314 on the request acceptance screen 1300 has been pressed. When the request acceptance button 1314 has been pressed (YES in Step S407), the process advances to Step S408.

In Step S408, the operation terminal 112 obtains the request information set input to the request acceptance screen 1300. The request information set here includes the examination type, the body part, the assignment characteristics, etc.

In Step S409, the operation terminal 112 transmits the request information set obtained in Step S408 to the remote interpretation server 101.

In Step S410, the remote interpretation server 101 receives the request information set transmitted from the operation terminal 112.

In Step S411, the remote interpretation server 101 stores the request information set received in Step S410 into the database 108. At this moment, the value of the status 2702, which indicates the status of the request information set, is changed to “Awaiting assignment”. Then, this process ends.

Request Assignment Process

FIG. 8 is a flowchart for the request assignment process executed by the operation terminal 112 and the remote interpretation server 101 cooperating with each other. The following processing steps are achieved by the respective CPUs of the operation terminal 112 and the remote interpretation server 101, reading out and executing the programs stored in each storing unit.

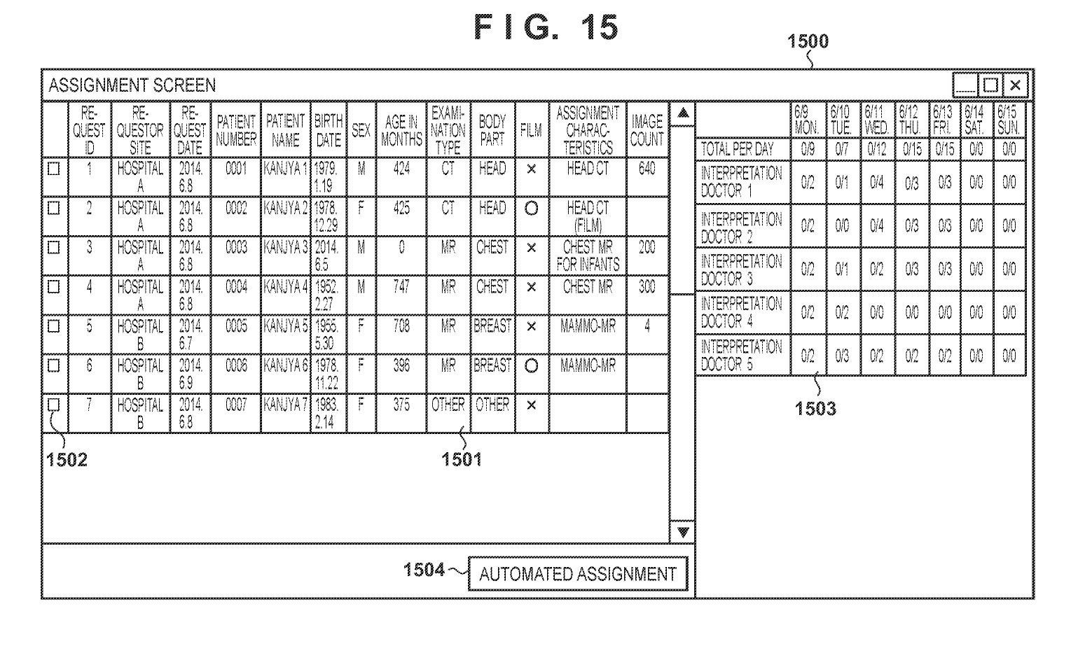

In Step S501, the operation terminal 112 displays a request assignment screen 1500, which is shown in FIG. 15, according to a user instruction. The operation terminal 112 may display the screen by using a Web browser (not shown in the drawings) that the operation terminal 112 is provided with, or display the screen with the aid of a predetermined application program. The request assignment screen 1500 includes an area for displaying a request information list 1501 and an area for displaying an interpretation doctor schedule 1503. In order to obtain the request information sets and the interpretation doctor schedule information sets to be displayed on the request assignment screen 1500, the operation terminal 112 provides the remote interpretation server 101 with an instruction to obtain each of the information sets.

In Step S502, the remote interpretation server 101 returns the request information sets that have the status indicating that assignment is awaited from among the request information sets in the request information table 2700 shown in FIG. 27, and the interpretation doctor schedule table 2600 shown in FIG. 26A, to the operation terminal 112. The operation terminal 112 displays the received request information sets and the interpretation doctor schedule table 2600 on the request assignment screen 1500.

In Step S503, the operation terminal 112 obtains request information sets that have been selected by the user via the request assignment screen 1500 and that are to be subjected to automated assignment.

In Step S504, the operation terminal 112 determines whether or not an automated assignment button 1504 on the request assignment screen 1500 has been pressed. When the automated assignment button 1504 has been pressed (YES in Step S504), the process advances to Step S505.

In Step S505, the operation terminal 112 transmits the request information sets that have been obtained in Step S503 and that are to be subjected to automated assignment, to the remote interpretation server 101.

In Step S506, the remote interpretation server 101 receives the request information sets that have been transmitted from the operation terminal 112 and that are to be subjected to automated assignment.

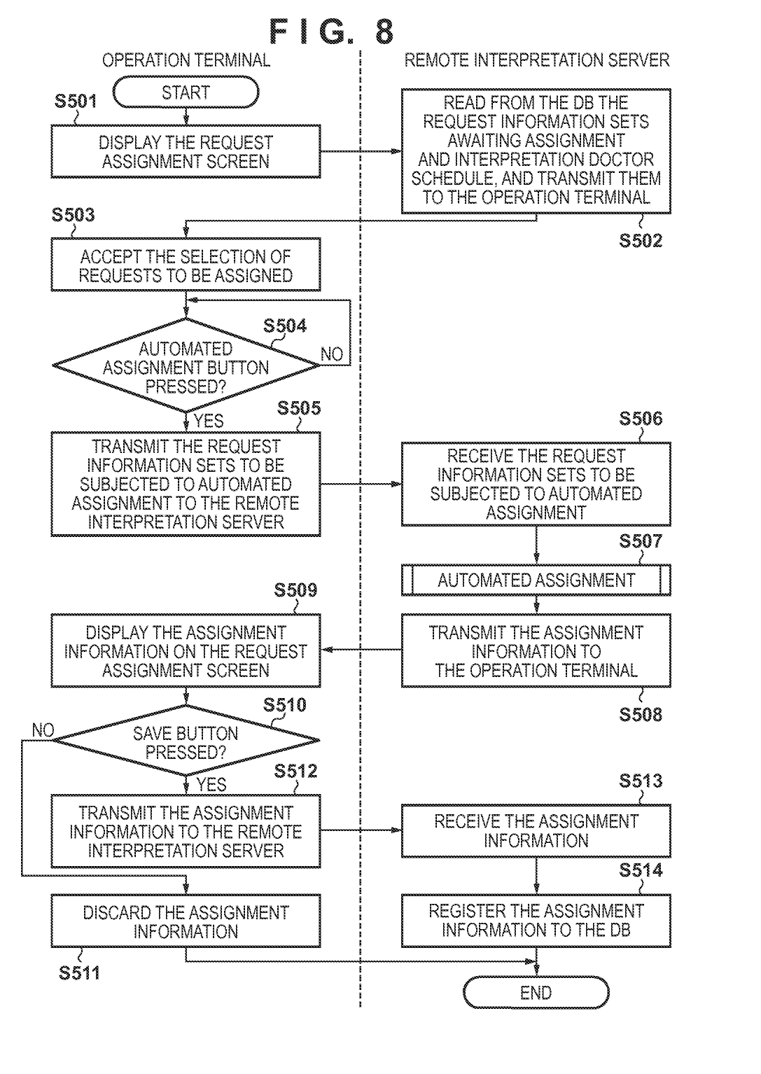

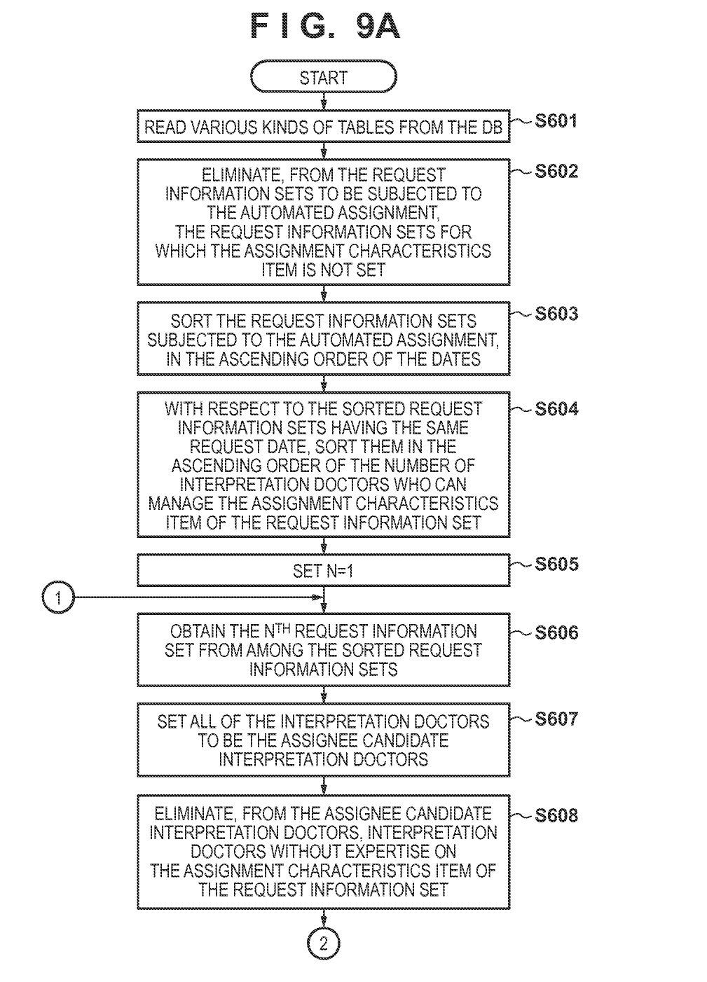

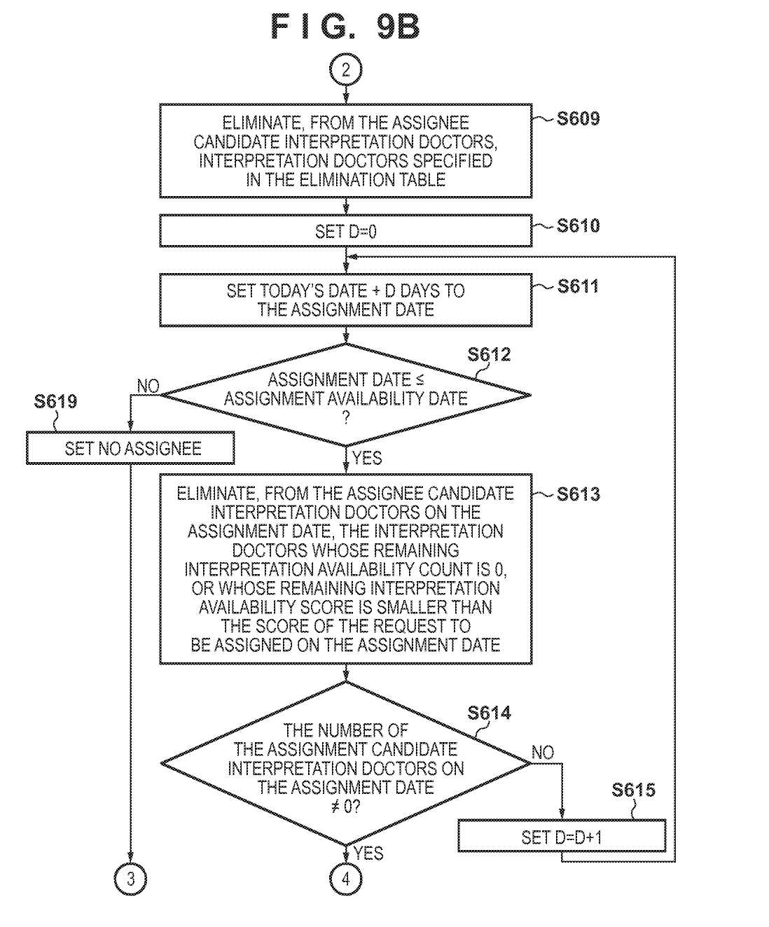

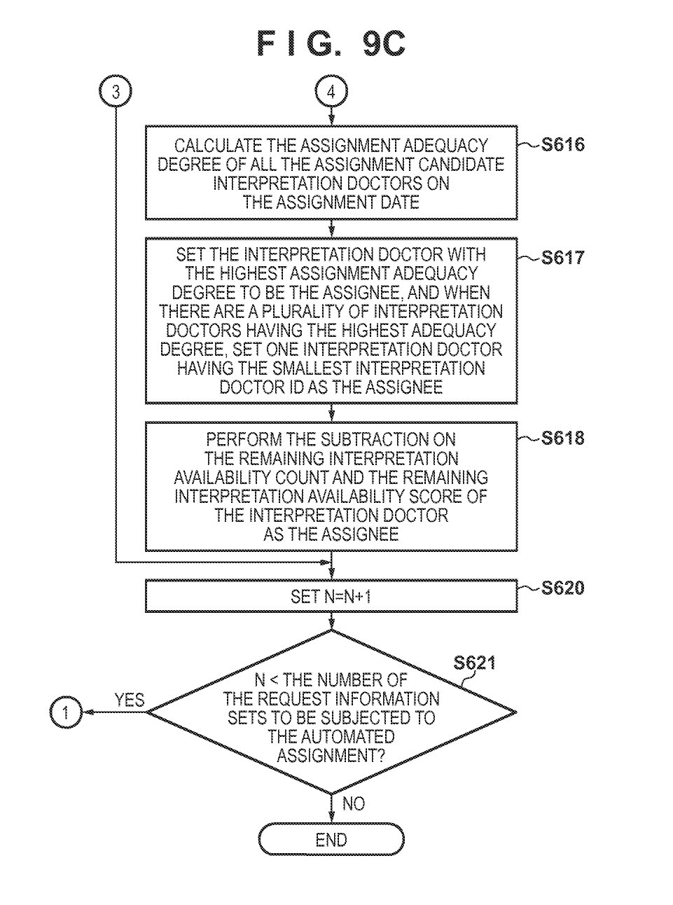

In Step S507, the remote interpretation server 101 executes the automated assignment process for each of the request information sets that are to be subjected to automated assignment, and sets assignment information. The assignment information here includes information about the interpretation doctor, who performs the interpretation work for the accepted request, and interpretation dates. The details of this process are described below with reference to FIGS. 9A, 9B, and 9C.

In Step S508, the remote interpretation server 101 transmits the assignment information that has been set in Step S507, to the operation terminal 112.

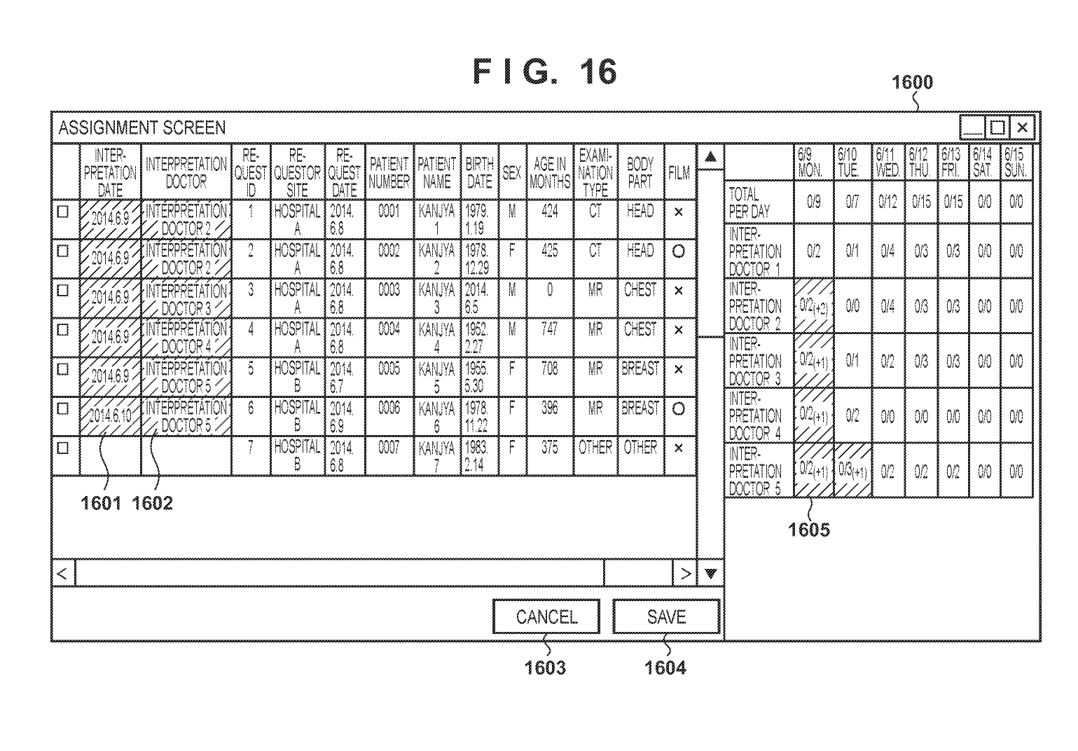

In Step S509, the operation terminal 112 displays the assignment information received from the remote interpretation server 101 on the request assignment screen 1500. The operation terminal 112 displays, in the request information list 1501 of the request assignment screen 1500, information about the interpretation doctors and interpretation dates to which each request information set has been assigned, in association with the request information set. Furthermore, the operation terminal 112 displays, in the interpretation doctor schedule 1503, the number of requests to be assigned on each date of each interpretation doctor. A conceptual illustration of the screen displayed after assignment is shown in FIG. 16. A request assignment screen 1600 shown in FIG. 16 includes a save button 1604 for accepting the confirmation of the results of the automated assignment, and a cancel button 1603 for accepting the cancellation.

In Step S510, the operation terminal 112 determines whether or not the save button 1604 on the request assignment screen 1600 has been pressed. When the save button 1604 has been pressed (YES in Step S510), the process advances to Step S512. When the cancel button 1603 has been pressed (NO in Step S510), the process advances to Step S511.

In Step S511, the operation terminal 112 discards the assignment information received in Step S509. The operation terminal 112 changes all of the assignment information displayed on the request assignment screen 1600 back to the state before being displayed (i.e., the state shown in FIG. 15). Then, this process ends.

In Step S512, the operation terminal 112 transmits the assignment information, for which the confirmation instruction from the user has been received, to the remote interpretation server 101.

In Step S513, the remote interpretation server 101 receives the assignment information from the operation terminal 112.

In Step S514, the remote interpretation server 101 updates the request information set stored in the database 108 by adding to it the assignment information received in Step S513. At this moment, the value of the status 2702, which indicates the status of the request information set, is changed to “Assigned”. Then, this process ends.

Automated Assignment Process

FIGS. 9A, 9B, and 9C are flowcharts for the automated assignment process executed by the remote interpretation server 101, which corresponds to Step S507 of FIG. 8.

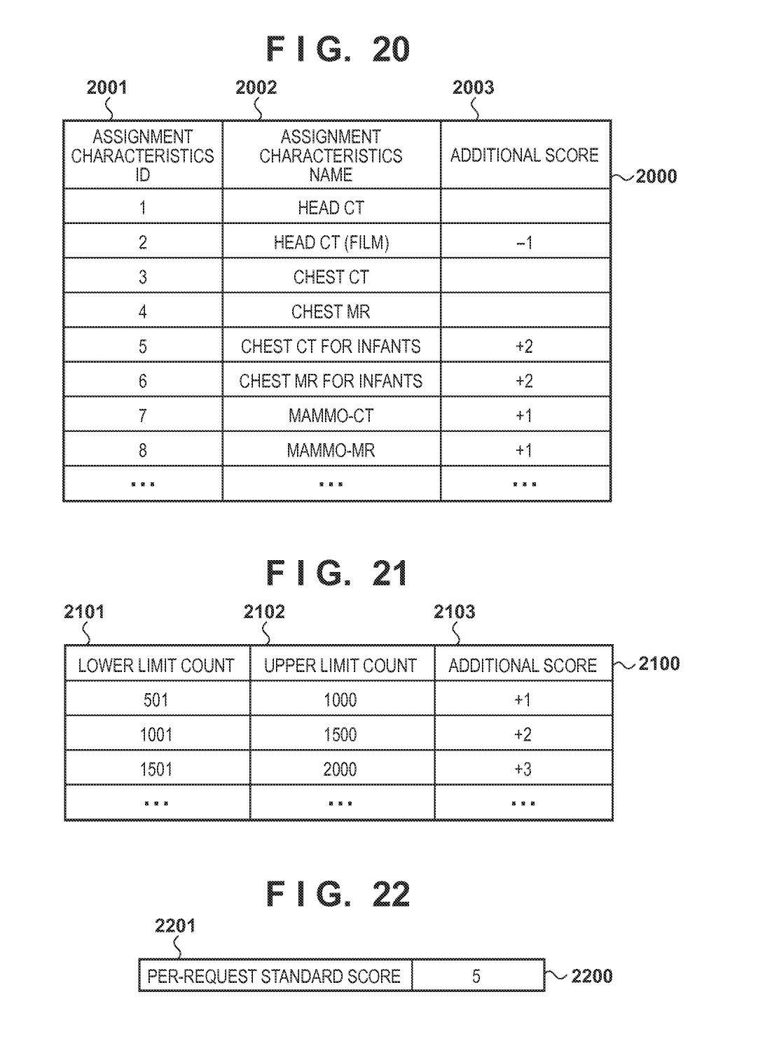

In Step S601, the remote interpretation server 101 obtains various kinds of tables stored in the database 108. The tables used here include an assignment characteristics master table 2000, a count score addition table 2100, a score setting table 2200, and an assignment characteristics mapping table 2300. The tables also include the expertness table 2400, an interpretation doctor elimination table 2500, and the interpretation doctor schedule table 2600. Examples of the configuration of each table are shown in FIG. 20 to FIG. 26B.

In Step S602, the remote interpretation server 101 eliminates, from the request information sets to be subjected to the automated assignment, the request information sets for which the assignment characteristics item is not set. Although each request information set is assumed to be provided with an assignment characteristics item via the request acceptance screen 1300 shown in FIG. 13, request information sets not matching any of the previously-registered assignment characteristics items are not provided with an assignment characteristics item. Since such request information sets cannot be automatically assigned by using the assignment characteristics items, such request information sets are eliminated in Step S602 from the request information sets to be subjected to the automated assignment. Note that such request information sets may be manually assigned as in the conventional case. When there are such request information sets, a screen for prompting the user (e.g. a clerk) to manually assign the request information sets may be displayed, for example.

In Step S603, the remote interpretation server 101 sorts the request information sets to be subjected to the automated assignment, in the ascending order of request date of the request information sets. In other words, as a result of the sorting, a request information set at a higher level is given a higher degree of priority, and is preferentially assigned to an interpretation doctor. The request dates of the request information sets correspond to request dates 2704 in the request information table 2700 shown in FIG. 27.

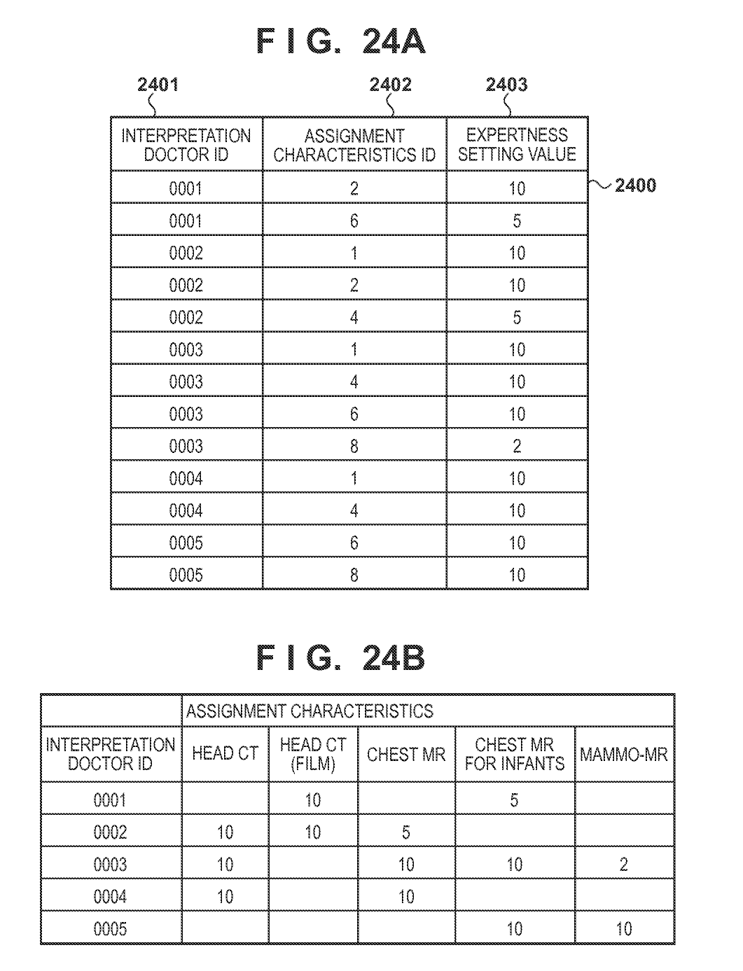

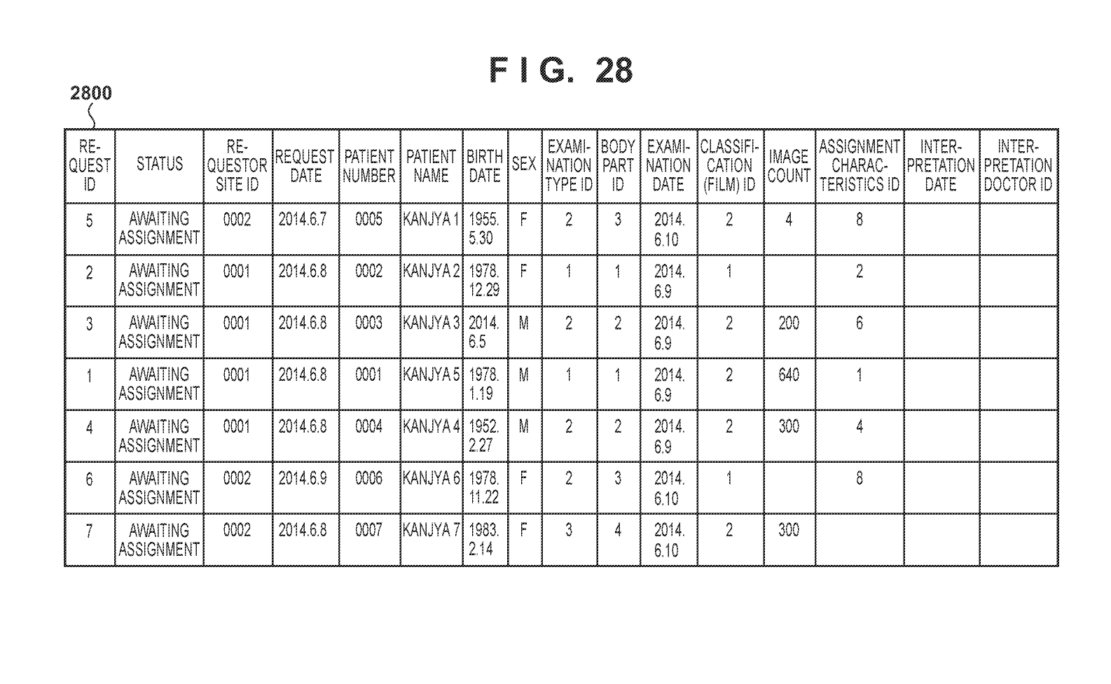

In Step S604, with respect to the request information sets having the same request date among the results of the sorting in Step S603, the remote interpretation server 101 sorts them in the ascending order of number of interpretation doctors who can handle the assignment characteristics of the request information set. The number of interpretation doctors here is determined based on the expertness table 2400 shown in FIG. 24A. For example, among the request information sets shown in the request information table 2700, the request information set with the request ID “7” is eliminated in Step S602 from the scope of the automated assignment. After the sorting based on the request dates 2704 and the expertness table 2400 performed in Step S603 and Step S604, the order of the request information sets will be as shown in FIG. 28.

In Step S605, the remote interpretation server 101 sets loop counter N to 1 (N=1) in order to perform a loop process sequentially on the request information sets sorted in Step S604.

In Step S606, the remote interpretation server 101 extracts the N^{th} request information set from among the request information sets sorted in Step S604, and treats it as a notable request information set to be subjected to assignment.

In Step S607, the remote interpretation server 101 treats all of the interpretation doctors included in the interpretation doctor schedule table 2600 obtained in Step S601, as assignee candidate interpretation doctors.

In Step S608, the remote interpretation server 101 refers to the expertness table 2400 obtained in Step S601, and eliminates, from the assignee candidate interpretation doctors that have been set in Step S607, an interpretation doctor whose expertness setting value (assignment characteristics value) corresponding to the assignment characteristics item of the request information set extracted in Step S606 is “0”. Note that when the expertness setting value of the assignment characteristics is “0”, it indicates that the interpretation doctor does not have the expertise (expertness) to conduct an image interpretation in the field concerned. When the value is a value other than “0”, the degree of proficiency in the field increases as the value increases. Note that the expertness setting value may be used not only for indicating the degree of expertise that the interpretation doctor has, but also for indicating the degree of the desire to conduct an image interpretation in the field concerned. Specifically, if an interpretation doctor sets a high expertness setting value with respect to a particular assignment characteristics item, request information sets having the assignment characteristics item will be preferentially assigned to the interpretation doctor. In other words, if an interpretation doctor desires to conduct an image interpretation with respect to a particular assignment characteristics item, the interpretation doctor may set the expertness setting value corresponding to the assignment characteristics item to be higher. In this way, the expertness setting value may be used as the degree of the interpretation doctor's desire (priority).

In Step S609, the remote interpretation server 101 refers to the interpretation doctor elimination table 2500 obtained in Step S601, and, in correspondence with the requestor facility contained in the request information set extracted in Step S606, eliminates the interpretation doctors that have been set as the interpretation doctors to be eliminated, from the assignee candidate interpretation doctors that have been set in Step S608.

In Step S610, the remote interpretation server 101 sets a loop counter D to “0” (D=0) in order to perform a loop process sequentially for each of the assignment dates in the interpretation doctor schedule table 2600 obtained in Step S601.

In Step S611, the remote interpretation server 101 sets “today's date+D days” as the assignment date. The remote interpretation server 101 sets the assignee candidate interpretation doctors at the present point in time as the assignee candidate interpretation doctors for the assignment date.

In Step S612, the remote interpretation server 101 compares the assignment date with an assignment availability date, and determines whether or not the assignment date is no greater than the assignment availability date. Here, the assignment availability date indicates, for example, a range from today to predetermined days later. Note that the assignment availability date may be determined by the user in advance. When the assignment date is no greater than the assignment availability date (YES in Step S612), the remote interpretation server 101 determines that the assignment date exists, and the process advances to Step S613. On the other hand, when the assignment date is greater than the assignment availability date (NO in Step S612), the remote interpretation server 101 determines that the assignment date does not exist, and the process advances to Step S619.

In Step S613, the remote interpretation server 101 refers to the assignment date of the interpretation doctor schedule, and eliminates, from the assignee candidate interpretation doctors on the assignment date, the interpretation doctors whose remaining interpretation availability count is 0, or whose remaining interpretation availability score is smaller than the score of the request to be assigned. According to the present embodiment, the remaining interpretation availability score is calculated by subtracting the total of the scores of the requests that have already been assigned to the interpretation doctor with respect to the assignment date, from the reference value obtained by (assignment availability count)×(per-request reference score 2201 of the score setting table 2200). In other words, the score indicates the load of the image interpretation, and when a request is assigned to an interpretation doctor and the load becomes high, control is performed so that no request will be newly assigned to the interpretation doctor. In this example, the reference value of the interpretation availability score is set as the upper limit of the load per day for each interpretation doctor. Note that the method for calculating the remaining interpretation availability score is not limited to the above, and it may be, for example, calculated by using a weighting or upper limit value that has been set for each interpretation doctor.

Also, the score of the request to be assigned is calculated by using the request information set extracted in Step S606, the assignment characteristics master table 2000, the count score addition table 2100, and the score setting table 2200. In the present embodiment, the score of the request to be assigned is calculated by (the per-request reference score 2201 of the score setting table 2200)+(an additional score 2003 of the assignment characteristics item indicated by the assignment information)+(an additional score 2103 of the image count indicated by the assignment information). In other words, the load of the interpretation based on the combination of the examination type and the body part to be examined and the load based the number of the images to be interpreted are taken into consideration. That is, a higher score indicates a higher load of a request. By not only considering the number of images to be interpreted, but also considering the load of each interpretation request by using the score, it is possible to assign requests taking into account uniform load distribution. Also, it is preferable to calculate the score of the request to be assigned when performing the automated assignment. This is because there is the possibility of receiving an additional image to be interpreted, after accepting an interpretation request.

In Step S614, the remote interpretation server 101 determines whether or not the number of the assignee candidate interpretation doctors on the assignment date is not 0. When the number is not 0 (YES in Step S614), the remote interpretation server 101 determines that there is an assignee candidate interpretation doctor on the assignment date, and the process advances to Step S616. When the number is 0 (NO in Step S614), the remote interpretation server 101 determines that there is no assignee candidate interpretation doctor on the assignment date, and the process advances to Step S615.

In Step S615, the remote interpretation server 101 adds 1 to the loop counter D (D=D+1), and the process advances to Step S611.

In Step S616, the remote interpretation server 101 refers to the interpretation doctor schedule table 2600 with respect to all of the assignee candidate interpretation doctors on the assignment date, and calculates the remaining interpretation availability count (an interpretation availability count 2603). The remote interpretation server 101 also refers to the expertness table 2400, and obtains the expertness setting value. Then, the remote interpretation server 101 calculates an assignment adequacy degree by multiplying the remaining interpretation availability count by the expertness setting value. For example, when the remaining interpretation availability count and the expertness setting value of a given assignee candidate interpretation doctor is 2 and 10 respectively, the value of the assignment adequacy degree is 20. Note that the formula for calculating the assignment adequacy degree is not limited to this, and another formula, for example a formula considering weighting for each assignment characteristics item, may be used.

In Step S617, the remote interpretation server 101 sets the interpretation doctor with the highest assignment adequacy degree to the assignment information, based on the assignment adequacy degree of each of the assignment candidate interpretation doctors calculated in Step S616. Note that when there are a plurality of interpretation doctors with the highest adequacy degree, one interpretation doctor with the smallest interpretation doctor ID, for example, is set to the assignment information, as the assignee.

In Step S618, with respect to the interpretation doctor as the assignee that has been set in Step S617, the remote interpretation server 101 subtracts 1 from the remaining interpretation availability count (the interpretation availability count 2603) of the assignment schedule on the assignment date. Furthermore, the remote interpretation server 101 subtracts the score corresponding to the request to be assigned, from the remaining interpretation availability score.

In Step S619, the remote interpretation server 101 determines that there is no assignment candidate interpretation doctor and no interpretation date, and does not set the assignment information. Then, the process advances to Step S620.

In Step S620, the remote interpretation server 101 adds 1 to the loop counter N (N=N+1).

In Step S621, the remote interpretation server 101 determines whether or not the value of N is smaller than the total number of the request information sets to be subjected to the automated assignment. When determining that N is smaller than the total number (YES in Step S621), the remote interpretation server 101 determines that there is a remaining request to be subjected to the automated assignment, and the process advances to Step S606. When determining that N is not smaller than the total number (NO in Step S621), the remote interpretation server 101 determines that the automated assignment process has been completed for all of the requests to be subjected to the automated assignment, and the process ends.

Examples of Screen Configuration

FIG. 10 shows an example of a requestor facility work list screen 1000 to be displayed on the display of the requestor terminal 109 when a user on the requestor facility makes a request application. When the display button 1001 on a request list 1006 is pressed, the screen transits to the request application screen 1100 for making an application with respect to the request information set in the row corresponding to the display button 1001. When a search button 1005 is pressed, the request information table 2700 shown in FIG. 27 is searched based on the conditions specified by the user, such as a patient number 1002, an examination type 1003, and a body part 1004, and the contents of the request list 1006 are updated.

FIG. 11 shows an example of the request application screen 1100 to be displayed on the display of the requestor terminal 109 when a user on the requestor facility inputs the contents of the request application in order to make a request application. A requestor 1101 is displayed according to the requestor facility to which the user belongs. A request date 1102 is date information to which the date on which the application of the request is made is to be set. The patient number 1103, a patient name 1104, a sex 1105, a birth date 1106, a modality 1107, and an image count 1108 are set and displayed based on examination information (DICOM information) included in the image data. When the request application button 1113 is pressed, the examination type 1109, the body part 1110, a film designation 1111, and information input to request details 1112 are registered in the request information table 2700.

FIG. 12 shows an example of the interpretation center work list screen 1200 to be displayed on the display of the operation terminal 112 when a user of the interpretation center accepts a request. When the display button 1201 on a request list 1207 is pressed, the screen transits to the request acceptance screen 1300 for accepting an application with respect to the request information set in the row corresponding to the display button 1201. When a search button 1206 is pressed, the request information table 2700 is searched based on conditions such as a requestor facility 1202, a patient number 1203, an examination type 1204, and a body part 1205, and the contents of the request list 1207 are updated.

FIG. 13 shows an example of the request acceptance screen 1300 to be displayed on the display of the operation terminal 112 when a user of the interpretation center inputs the details of request acceptance in order to accept a request. Based on the request information set that has been set to the request information table 2700, a requestor 1301, a request date 1302, a patient number 1303, a patient name 1304, a sex 1305, a birth date 1306, a modality 1307, and an image count 1308 are displayed. Furthermore, an examination type 1309, a body part 1310, a film 1311, and request details 1312 are displayed. The assignment characteristics selection list 1313 shows a list of assignment characteristics names registered in the assignment characteristics master table 2000 shown in FIG. 20. When the request acceptance button 1314 is pressed, the assignment characteristics item selected from the assignment characteristics selection list 1313 is registered in the request information table 2700.

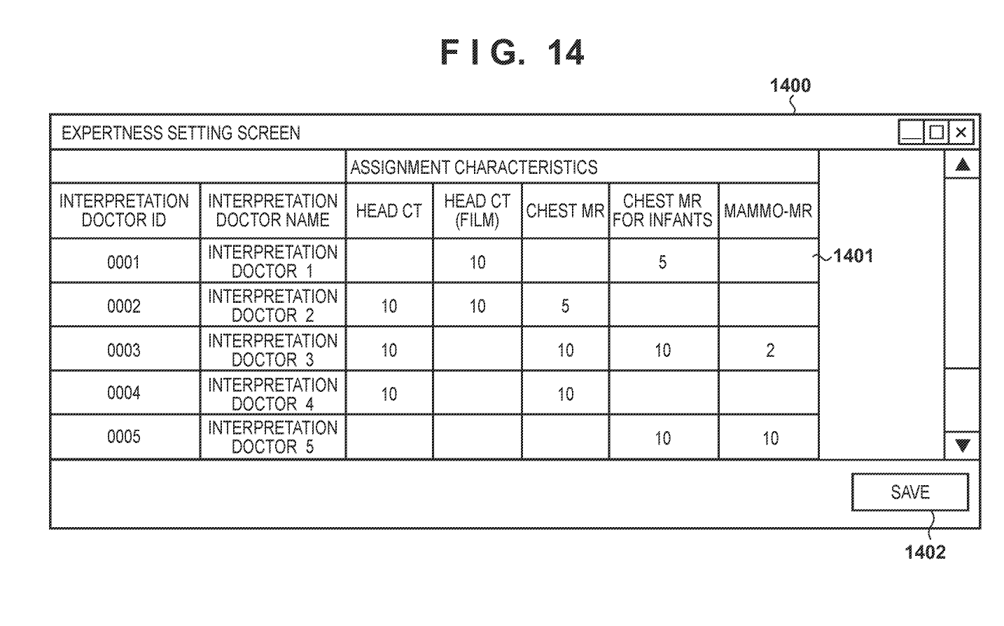

FIG. 14 shows an example of an expertness setting screen 1400 to be displayed on the display of the operation terminal 112 when a user of the interpretation center updates the contents of the expertness table 2400 shown in FIG. 24A. When the user presses a save button 1402 after inputting to the expertness setting value 1401 a value indicating the expertness with respect to each assignment characteristics item, the expertness table 2400 is updated. A larger value here indicates a higher degree of expertise. Note that if there is no input value, it indicates that the item is out of the area of expertise of the doctor (or the interpretation doctor is not able to conduct the image interpretation).

FIG. 15 shows an example of the configuration of the request assignment screen 1500 to be displayed on the display of the operation terminal 112 when a user of the interpretation center assigns a request information set to an interpretation doctor. When the automated assignment button 1504 is pressed, the request information set selected with an assignee selection check box 1502 on the request information list 1501 is subjected to automated assignment, and the results of the assignment (FIG. 16) are displayed. When a cell of the interpretation doctor schedule 1503 is selected by the user, the request information table 2700 is updated with respect to the request information set selected with the assignee selection check box 1502 on the request information list 1501, using the interpretation doctor and the assignment date indicated by the cell as the assignment information. In other words, it is possible to manually assign interpretation requests to interpretation doctors, instead of automatically assigning interpretation requests to interpretation doctors in response to the automated assignment button 1504 being pressed.

FIG. 16 is a screen showing assignment results, which is to be displayed on the display of the operation terminal 112 when a user of the interpretation center issues an instruction for automated assignment. When automated assignment is executed, an interpretation date column 1601 and an interpretation doctor column 1602 are additionally displayed, and the interpretation dates and the interpretation doctors are displayed in these columns as the results of the assignment. Furthermore, the total number of the requests after the assignment and the number of the newly assigned requests are displayed in the cells of the interpretation dates and the interpretation doctors of the interpretation doctor schedule 1605 corresponding to the assignment.

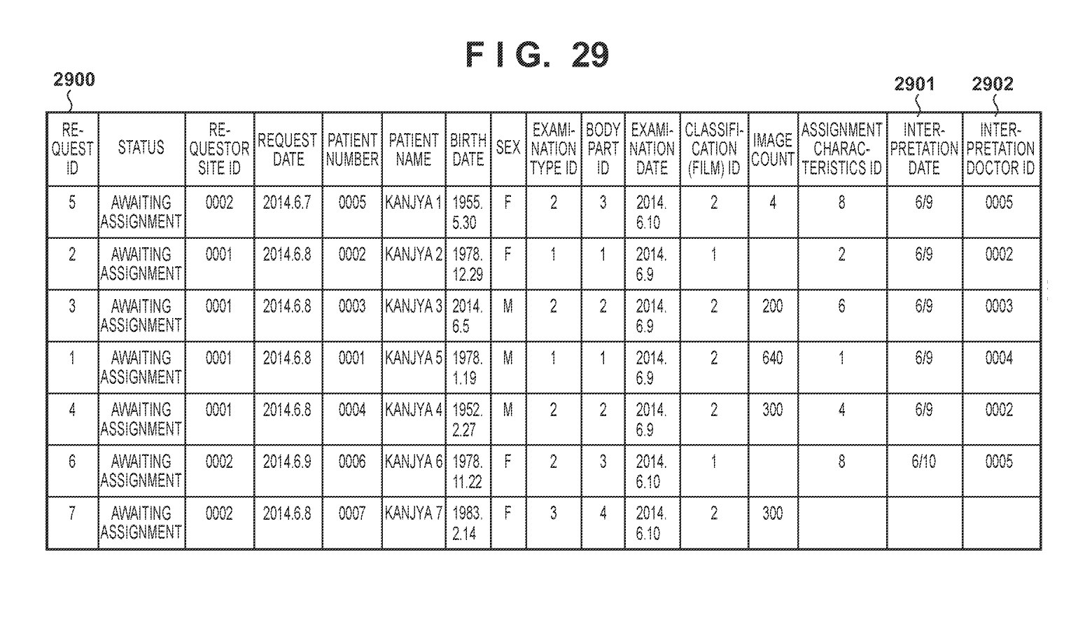

When the cancel button 1603 is pressed, the content of the interpretation dates and the interpretation doctors that have been displayed provisionally are discarded. As a result, the interpretation date column 1601 and the interpretation doctor column 1602 are hidden, and the number of the newly assigned requests in the interpretation doctor schedule 1605 is deleted. When the save button 1604 is pressed, the contents of the interpretation dates and the interpretation doctors that have been displayed are registered and confirmed in a request information table 2900 as shown in FIG. 29.

Examples of Configurations of Tables

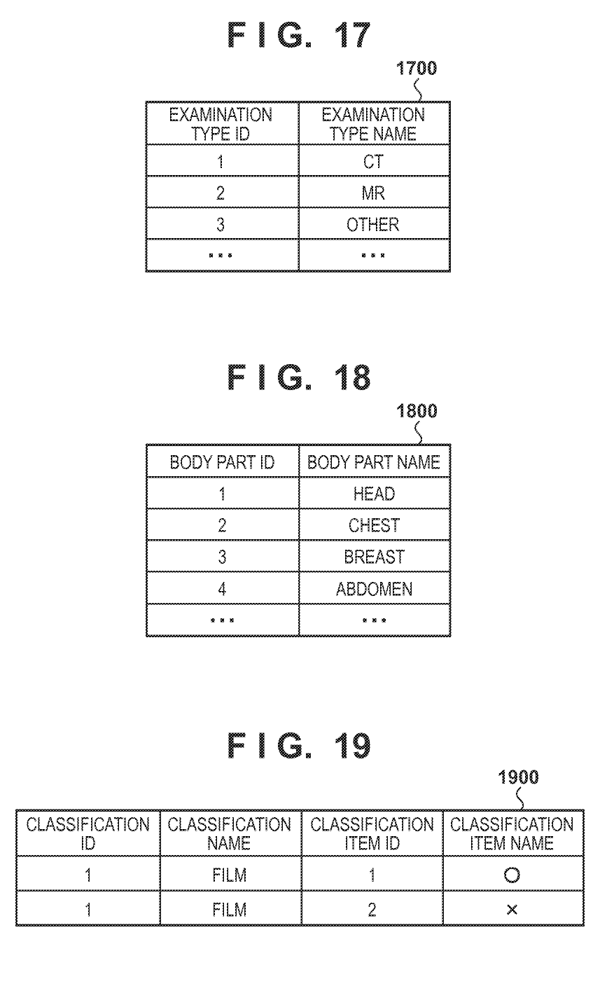

FIG. 17, FIG. 18 and FIG. 19 show examples of the configurations of master tables stored in the database 108. The data registered in an examination type table 1700 shown in FIG. 17, a body part table 1800 shown in FIG. 18, and a classification table 1900 shown in FIG. 19 are displayed on the request application screen 1100 shown in FIG. 11 in the form of a list for example, as candidates for inputting the values of the request information set.

FIG. 20 shows an example of the configuration of the assignment characteristics master table 2000 stored in the database 108. The assignment characteristics according to the present embodiment are defined by the combination of any one of the values of the examination types shown in FIG. 17 and any one of the values of the body parts shown in FIG. 18. Note that the assignment characteristics items are not limited to this, and may be defined by the combination of the values of further detailed items. If this is the case, the expertness can be defined in more detail. The assignment characteristics master table 2000 includes assignment characteristics IDs 2001, assignment characteristics names 2002, and additional scores 2003. Regarding the additional scores 2003, when calculating the score of a request information set, the additional score 2003 corresponding to the assignment characteristics item that has been set to the request information set is added to the per-request reference score 2201 (FIG. 22).

FIG. 21 shows an example of the configuration of the count score addition table 2100 stored in the database 108. The count score addition table 2100 includes lower limit counts 2101, upper limit counts 2102, and additional scores 2103. When calculating the score of a request information set in Step S613 and Step S618 shown in FIGS. 9B and 9C, the additional score 2103 of the record defining the range between the lower limit count 2101 and the upper limit count 2102 within which the number of the images of the request information set is included is added to the per-request reference score 2201.

FIG. 22 shows an example of the configuration of the score setting table 2200 stored in the database 108. The score setting table 2200 includes a per-request reference score 2201. This score is used as a reference score for one request.

FIG. 23 shows an example of the configuration of the assignment characteristics mapping table 2300 stored in the database 108. The assignment characteristics mapping table 2300 includes assignment characteristics IDs 2301, assignment characteristics names 2302, examination type IDs 2303, body part IDs 2304, classification IDs 2305, patient's age lower limit values 2306, patient's age upper limit values 2307, and patient's sexes 2308. Each of the same assignment characteristics IDs 2301 may have a different combination of the examination type ID 2303, the body part ID 2304, the classification ID 2305, the patient's age lower limit value 2306, the patient's age upper limit value 2307, and the patient's sex 2308.

FIG. 24A shows an example of the configuration of the expertness table 2400 stored in the database 108. The expertness table 2400 includes interpretation doctor IDs 2401, assignment characteristics IDs 2402, and expertness setting values 2403. The values (parameters) input from the expertness setting screen 1400 shown in FIG. 14 are registered in this table. These parameters indicate the expertness of each interpretation doctor, and a higher value indicates a higher degree of expertness. FIG. 24B is a two-dimensional table showing the relationship among the values shown in FIG. 24A, where the interpretation doctors and the assignment characteristics items are represented by the axes.

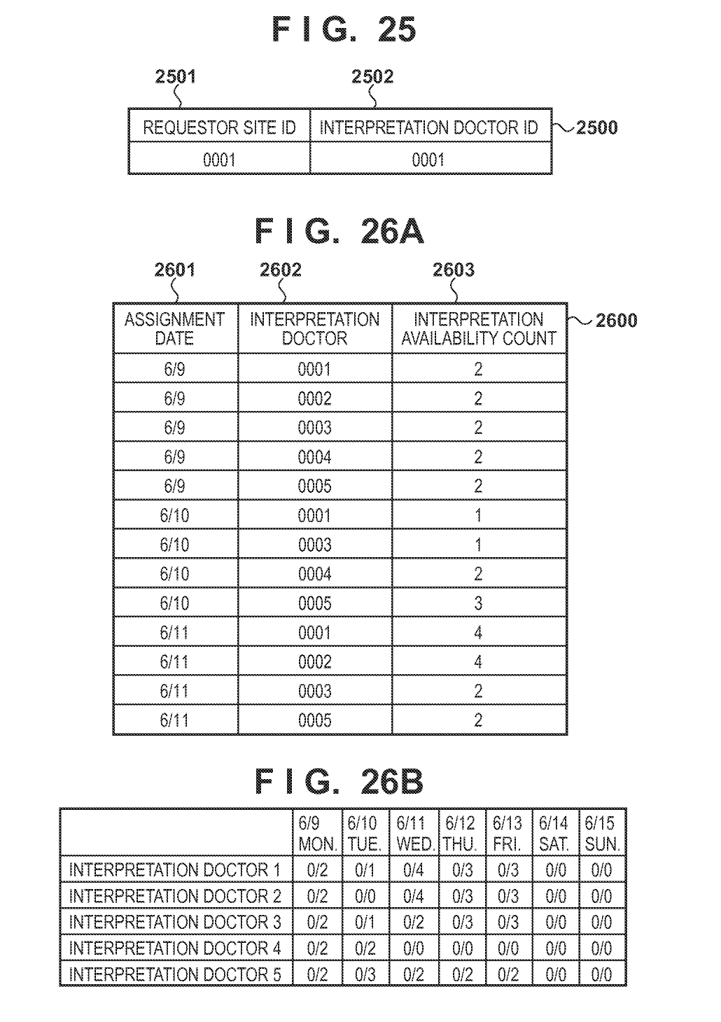

FIG. 25 is an example of interpretation doctor elimination table 2500 stored in the database 108. The interpretation doctor elimination table 2500 includes a requestor facility ID 2501 and an interpretation doctor ID 2502. The interpretation doctor elimination table 2500 is used for eliminating, from the candidate interpretation doctors, interpretation doctors that are not desired by the requestor facility that made an application with respect to a request information set. Although this example shows that the interpretation doctor to be eliminated is designated for each requestor facility, the designation is not limited to this method. For example, the interpretation doctors to be eliminated may be designated for each patient, for each examination type, etc.

FIG. 26A shows an example of the configuration of interpretation doctor schedule table 2600 stored in the database 108. The interpretation doctor schedule table 2600 includes assignment dates 2601, interpretation doctor IDs 2602, and interpretation availability counts 2603. FIG. 26B is a two-dimensional table showing the values shown in FIG. 26A, where the assignment dates and the interpretation doctors are represented by the axes.

FIG. 27 shows an example of the configuration of the request information table 2700 stored in the database 108. The request information table 2700 includes request IDs 2701, statuses 2702, requestor facility IDs 2703, request dates 2704, patient numbers 2705, patient names 2706, birth dates 2707, and sexes 2708. The request information table 2700 also includes examination type IDs 2709, body part IDs 2710, examination dates 2711, classification (film) IDs 2712, image counts 2713, assignment characteristics IDs 2714, interpretation dates 2715 and interpretation doctor IDs 2716. These are attribute information included in each request information set. In particular, according to the present embodiment, the combination of an examination type indicated by an examination type ID 2709 and a captured body part indicated by a body part ID 2710 is used for processing for association with the degrees of expertness of the interpretation doctors. FIG. 28 shows the state of the data sets in the request information table 2700 shown in FIG. 27 after being sorted (after Steps S601 to S604 are performed).

FIG. 29 shows the results of the process according to the flowchart shown in FIGS. 9A, 9B, and 9C, performed on the data sets in the request information table 2700 shown in FIG. 27. The assignment dates and the assignment interpretation doctors after the automated assignment have been set to the interpretation dates 2901 and the interpretation doctor IDs 2902. Note that these data sets have not been stored in the database 108 in the data center at the time the process according to the flowchart shown in FIGS. 9A, 9B, and 9C is completed, and they are stored in the database 108 when the user makes an instruction to save the data sets via the request assignment screen 1600 in Step S514 of the flowchart shown in FIG. 8.

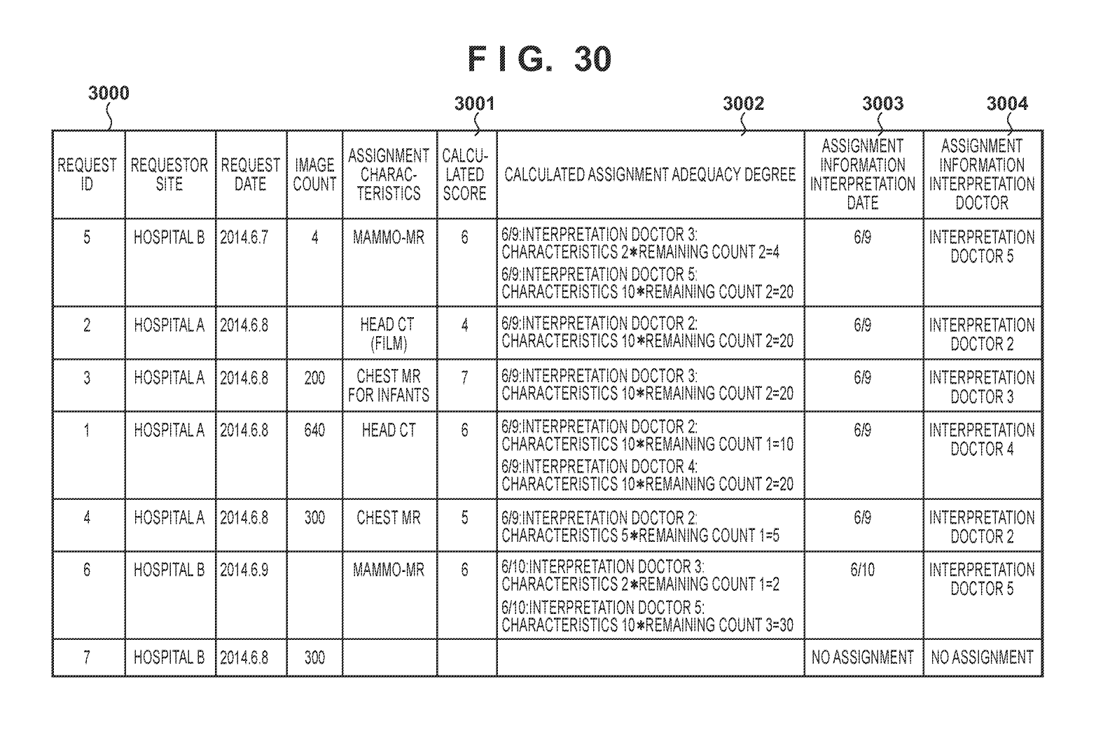

FIG. 30 shows the state of the data sets in the request information table 2700 at the time the process according to the flowchart shown in FIGS. 9A, 9B, and 9C is completed. Calculated scores 3001 indicate the scores of the requests calculated in Step S613 of FIG. 9B. Calculated assignment adequacy degrees 3002 indicate the assignment adequacy degrees of the interpretation doctors for each of the assignment dates, calculated in Step S616 of FIG. 9C. Assignment information interpretation dates 3003 and assignment information interpretation doctors 3004 indicate the results with respect to the interpretation dates and the interpretation doctors, which have been set in Step S617 to be subjected to the assignment.

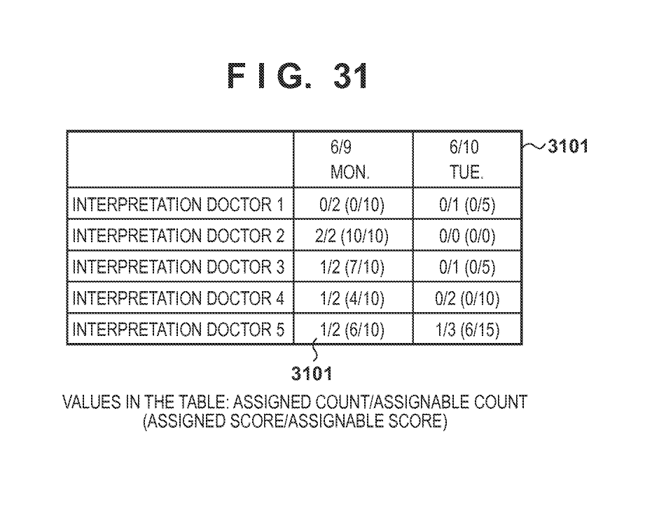

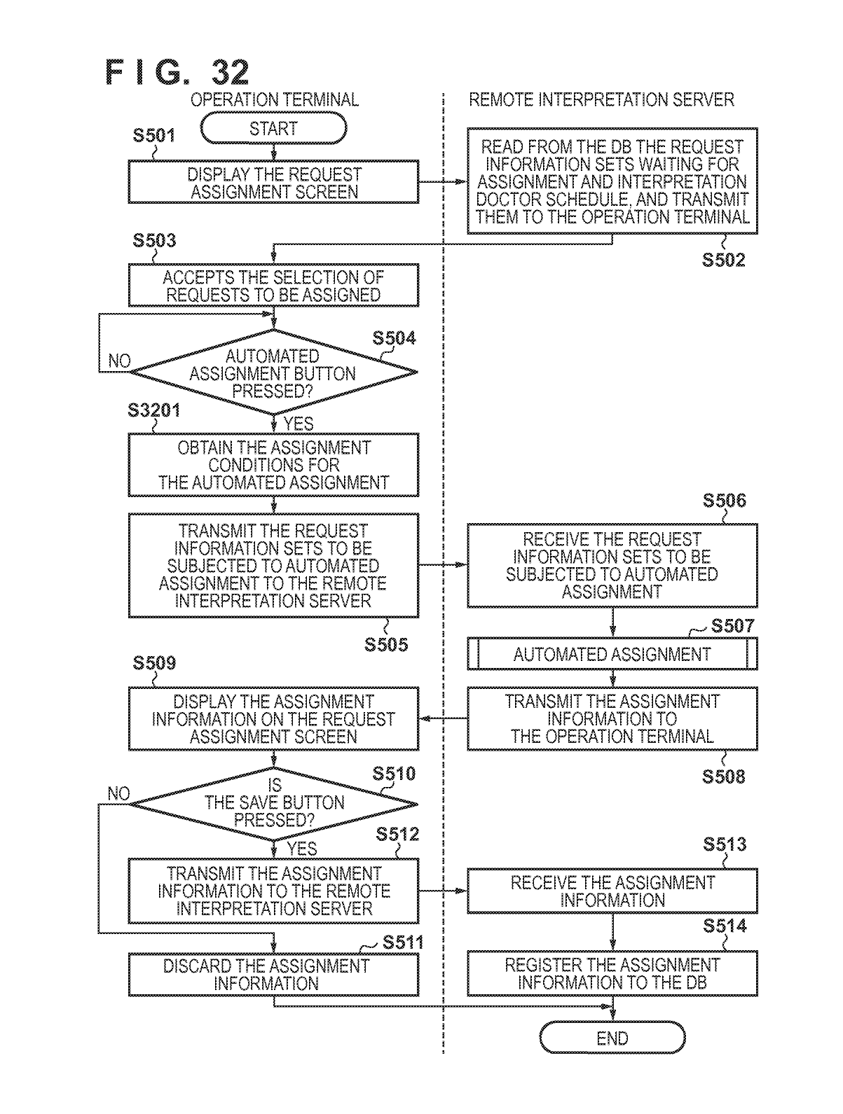

FIG. 31 shows, with respect to the data sets in the request information table 2700, the state of the assigned count, the assignable count, the assigned score, and the assignable score for each assignment date and each interpretation doctor at the time the process according to the flowchart shown in FIGS. 9A, 9B, and 9C is completed.

### Second Embodiment

By using the mechanism described as the first embodiment, it is possible to automatically assign the interpretation requests received by the interpretation center to interpretation doctors, taking into consideration the degree of expertness of the interpretation doctors and the loads of the requests. However, when the number of requests is greater than the interpretation availability count of each day, requests occurring after the automated assignment are always given lower priority than already assigned requests, even if they are urgent requests. Therefore, when interrupting a request with another request is desired, there is the problem that it is necessary to manually adjust the assignments, and such readjustment takes a long time.

Also, when improving the efficiency of interpretation by assigning requests on the same patient to the same interpretation doctor and the same date is desired, it is necessary to manually adjust the assignments.

There also is a desire to preferentially assign request information sets from a particular requestor.

According to the present embodiment, in order to solve the problems above, if interrupting a request with another request is desired, a quota for interruption is prepared at the time of the automated assignment without using all the quotas available for interpretation. This configuration allows for the interruption with a request occurring after the assignment, while retaining the results of the assignment that has already been made. Furthermore, according to the present embodiment, requests for the same patient, etc. are grouped. By this grouping, requests for the same patient, etc. are always assigned to the same interpretation doctor, the same interpretation date, etc., and the time and effort required for the manual adjustment of the assignments can be reduced.

The following provides a description of the mechanism above as a second embodiment. Note that the processes and the examples of screens that are the same as in the above-described first embodiment are omitted, and a description is given of the differences from the first embodiment.

Note that, according to the present embodiment, the user can set the degrees of urgency for the requests, via the request application screen 1100. It is acceptable that the application of a request with high degree of urgency can be set only by a particular user or a particular requestor.

Flowcharts

Request Assignment Process

FIG. 32 is a flowchart for a request assignment process executed by the operation terminal 112 and the remote interpretation server 101 cooperating with each other. The following processing steps are achieved by the respective CPUs of the operation terminal 112 and the remote interpretation server 101, reading out and executing the programs stored in each storing unit.

In Step S504, the operation terminal 112 determines whether or not the automated assignment button 1504 on the request assignment screen 1500 has been pressed. When the automated assignment button 1504 has been pressed (YES in Step S504), the process advances to Step S3201.

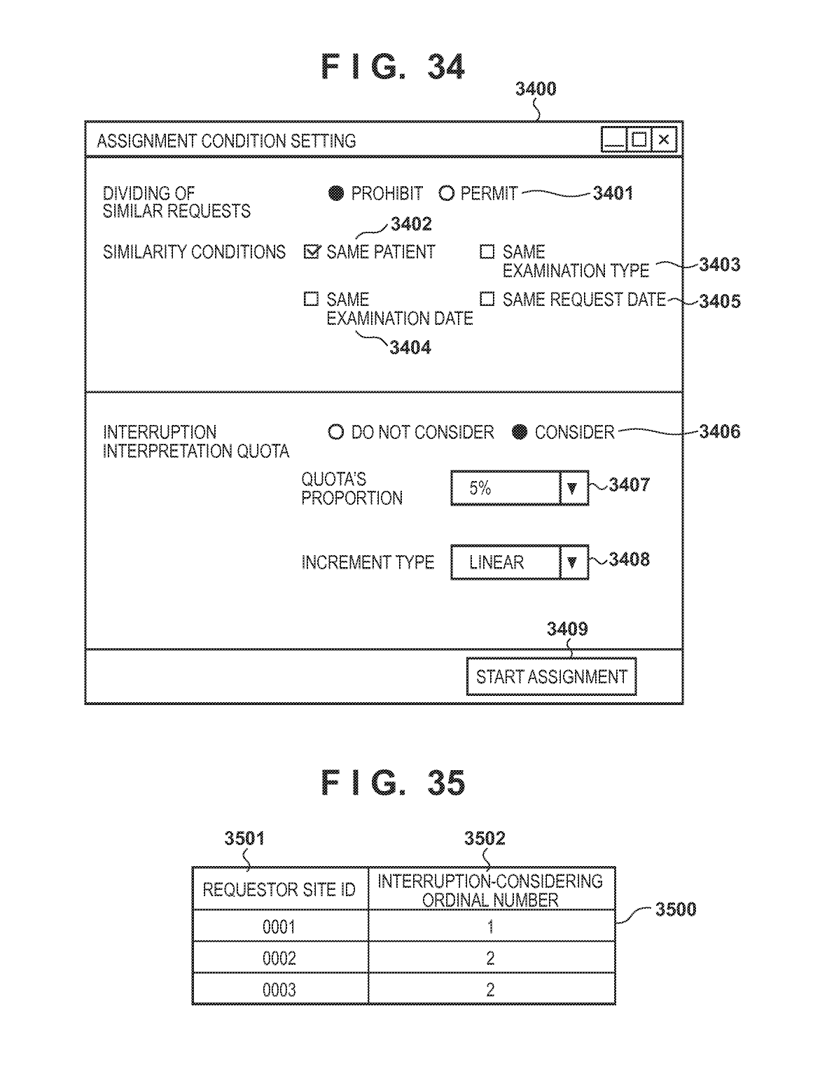

In Step S3201, the operation terminal 112 obtains the conditions for the automated assignment selected by the user via a request assignment condition input screen 3400 shown in FIG. 34. The assignment conditions may be set by displaying the request assignment condition input screen 3400 when the automated assignment button 1504 is pressed. Alternatively, a selection by the user as an advance setting may be received by displaying the request assignment condition input screen 3400 in advance. The configuration of the request assignment condition input screen 3400 will be described later. When detecting that an assignment start button 3409 has been pressed, the operation terminal 112 obtains the assignment conditions input from the request assignment condition input screen 3400, and the process advances to Step S505.

In Step S505, the operation terminal 112 transmits the request information sets that have been obtained in Step S503 and that are to be subjected to automated assignment, and the assignment conditions obtained in Step S3201, to the remote interpretation server 101.

Automated Assignment Process

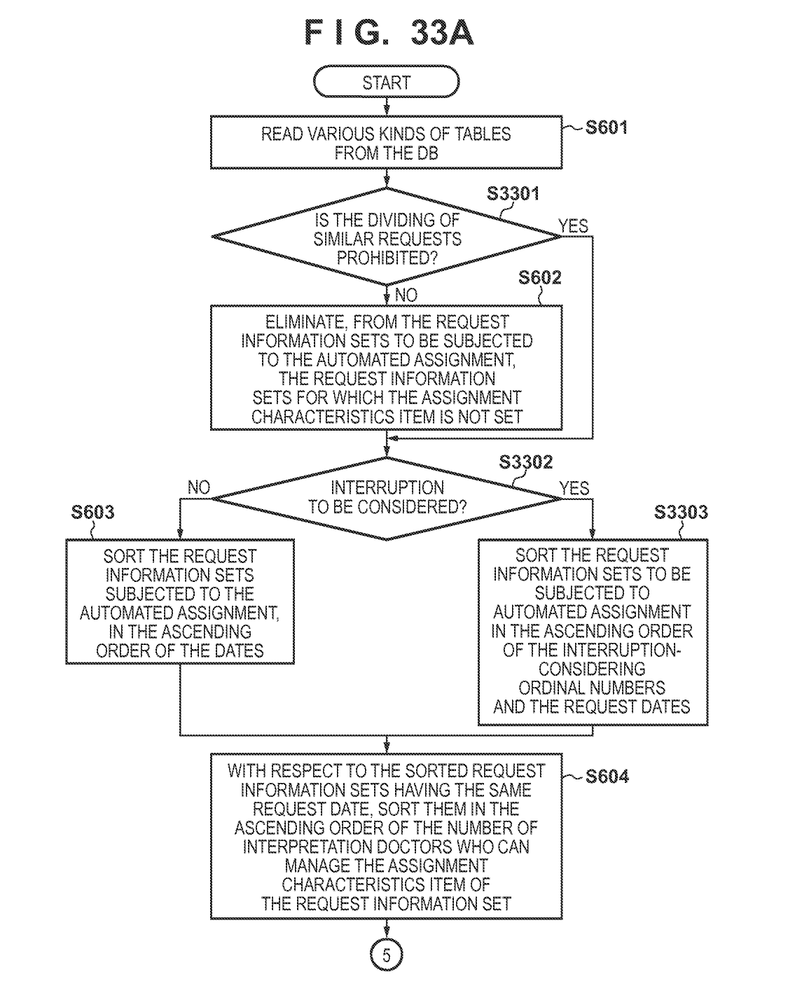

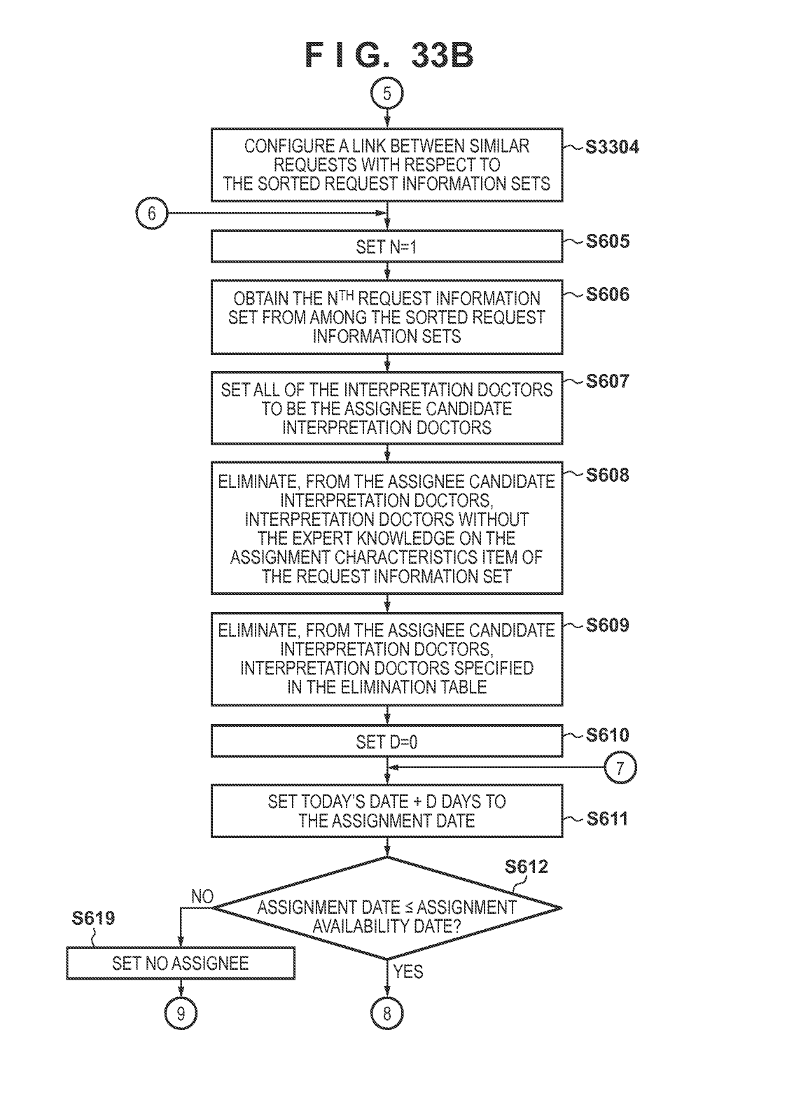

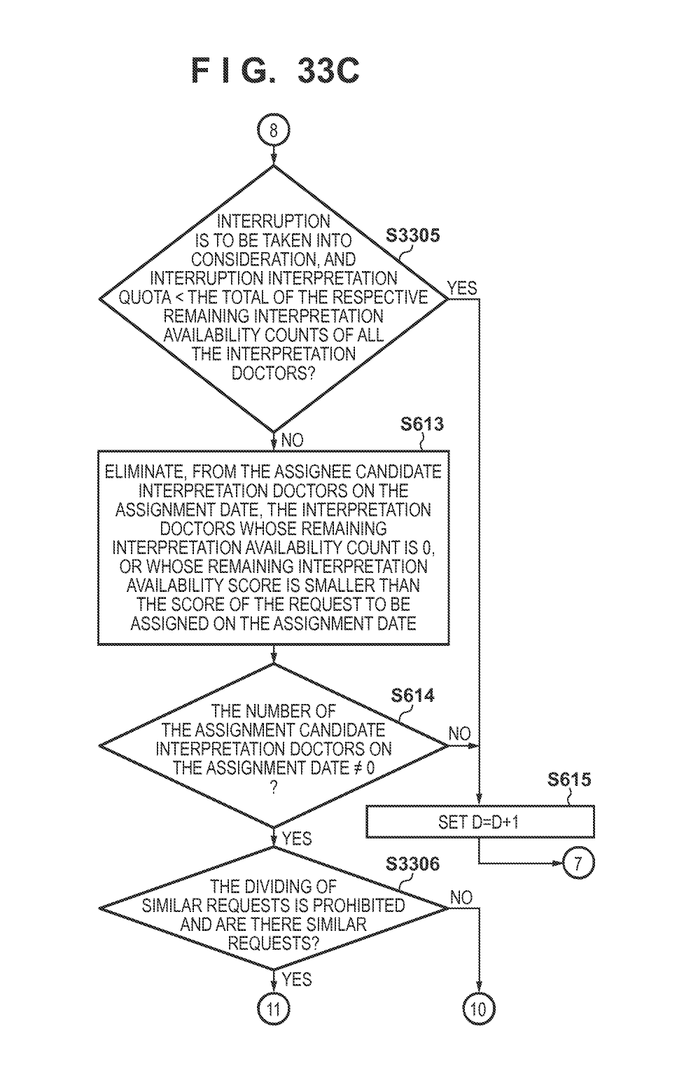

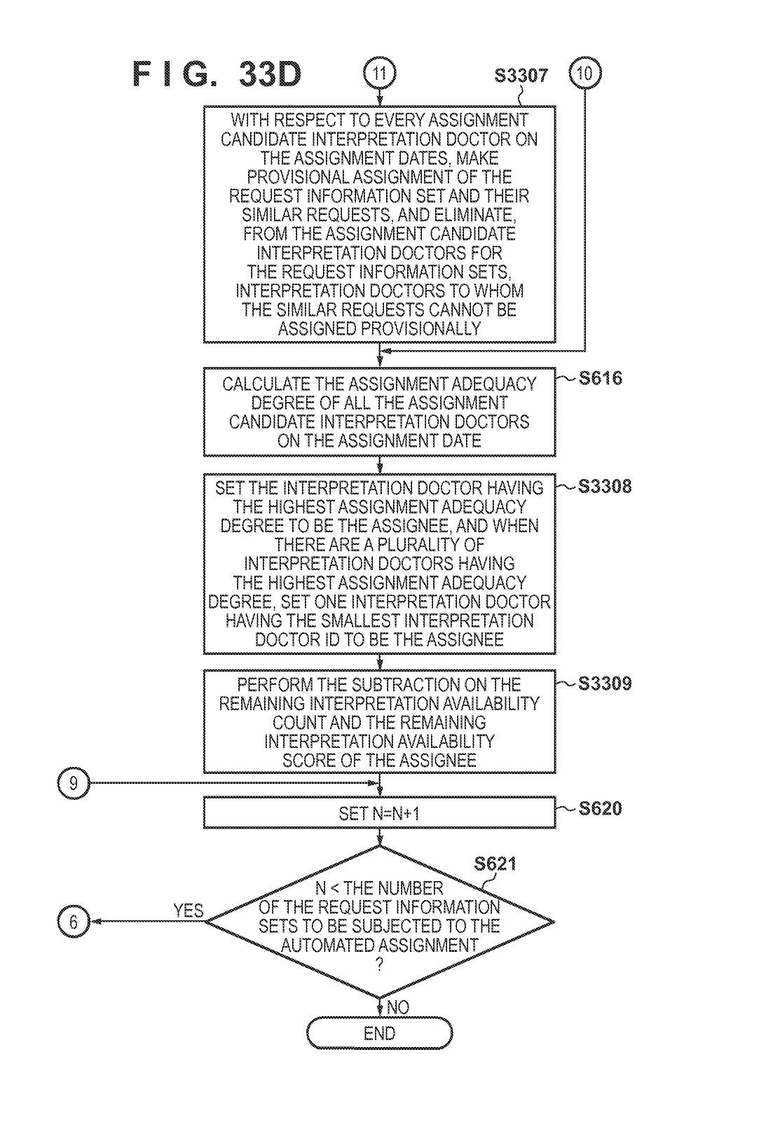

FIGS. 33A, 33B, 33C and 33D are flowcharts for the automated assignment process executed by the remote interpretation server 101 according to the present embodiment, which correspond to Step S507 of FIG. 32.

In Step S601, the remote interpretation server 101 obtains various kinds of tables stored in the database 108. The tables obtained at this point include the assignment characteristics master table 2000, the count score addition table 2100, the score setting table 2200, and the assignment characteristics mapping table 2300. The tables also include the expertness table 2400, the interpretation doctor elimination table 2500, the interpretation doctor schedule table 2600, and a facility information table for interruption 3500. Examples of the configuration of each table are shown in FIG. 20 to FIG. 26B, and FIG. 35. Note that the tables other than the facility information table for interruption 3500 have the same configurations as the configurations described for the first embodiment.

In Step S3301, the remote interpretation server 101 determines whether or not the dividing of similar requests is prohibited, based on the assignment conditions input via the request assignment condition input screen 3400. Specifically, whether or not the dividing of similar requests is prohibited is determined based on the setting to a similar request dividing 3401. “Similar requests” mentioned above indicate request information sets that are treated to be similar based on a predetermined attribute. The predetermined attribute is set from the request assignment condition input screen 3400 shown in FIG. 34. For example, when “same patient” is set as the similarity condition from the request assignment condition input screen 3400, requests related to a same patient are treated as similar requests to each other.

When the dividing of similar requests is prohibited (YES in Step S3301), Step S602 is skipped, and the process advances to Step S3302. When the dividing of similar requests is not prohibited (NO in Step S3301), the process advances to Step S602. When the dividing of similar requests is not prohibited, the assignment process is improved in its efficiency by, as in the first embodiment, excluding the interpretation requests to which no assignment characteristics item is set, from the requests to be subjected to assignment. On the other hand, when the dividing of similar requests is prohibited, similar requests are determined to be subjected to assignment, even if they are interpretation requests to which no assignment characteristics item is set. For this reason, in this case, requests to which no assignment characteristics item is set are not excluded from the requests to be subjected to assignment.

In Step S3302, the remote interpretation server 101 checks the setting as to whether or not to consider interruption, based on the specified assignment conditions for automated assignment. Specifically, whether or not to consider interruption is determined based on the setting of an interruption interpretation quota 3406 on the request assignment condition input screen 3400. “Consider interruption” here indicates that when the interpretation availability count is greater than the number of requests, an unused quota is prepared instead of using all quotas. This is the mechanism for interrupting a request with another request with a high degree of urgency and a high priority (i.e., processing a request with a high degree of urgency in advance). With this configuration, even when a request with high priority occurs after the assignment, it is possible to assign the request without cancelling the assignment that has been determined. In the case of considering interruption (YES in Step S3302), the process advances to Step S3303. In the case of not considering interruption (NO in Step S3302), the process advances to Step S603.

In Step S3303, the remote interpretation server 101 sorts the request information sets to be subjected to automated assignment. As the reference for sorting, an interruption-considering ordinal number 3502, which is set to the requestor facility of each request information set in the facility information table for interruption 3500 shown in FIG. 35, is used as the first sort key. Also, the request date 2704 of each request information set in the request information table 2700 shown in FIG. 27 is used as the second sort key. Sorting in the ascending order is performed with respect to each sort key. In other words, as a result of sorting, a request information set at a higher level is given a higher priority, and is preferentially assigned to an interpretation doctor. In Step S3303, a request from a requestor facility with higher order in terms of the interruption-considering ordinal number 3502 is preferentially assigned to an interpretation doctor. Then, the process advances to Step S604.

After Step S604, in Step S3304, the remote interpretation server 101 configures, with respect to the request information sets, a link between similar requests, based on the conditions for similar requests specified in the assignment conditions (the setting items 3402 to 3405). The remote interpretation server 101 extracts the request information sets, which have been sorted in Step S604, one by one from the top, and, from among the subsequent requests, sets the requests that match the conditions for similar requests to be the similar requests. The only necessity here is that the similar requests are linked with each other, and the method for linking is not limited to any particular method. Also, it is possible to employ a configuration for not searching for similar requests until Step S3307 described later, instead of setting the link in advance. Then, the process advances to Step S605.

In Step S612, the remote interpretation server 101 compares the assignment date with the assignment availability date, when the assignment date is no greater than the assignment availability date (YES in Step S612), the process advances to Step S3305. In Step S3305, in the case where interruption is taken into consideration by the specified assignment conditions for automated assignment, the remote interpretation server 101 determines whether or not the total of the remaining interpretation availability counts of all the interpretation doctors on the assignment dates at the time of the processing is greater than the interruption interpretation quota. “Interruption interpretation quota” indicates the interpretation availability count that has been prepared for each assignment date in advance, considering the occurrence of urgent interruption requests. The interruption interpretation quota is set for each assignment date, based on a quota's proportion 3407 and an increment type 3408 of the assignment conditions, which are set via the request assignment condition input screen 3400 shown in FIG. 34. For example, in the case where a quota's proportion 3407 is “5%” and the increment type 3408 is “linear”, when the total interpretation availability count of all the interpretation doctors on the first assignment date is 200, the interruption interpretation quota for the first assignment date is 10, because the quota's proportion is 5%. When the total interpretation availability count of all the interpretation doctors on the next assignment date is 180, the interruption interpretation quota for the next assignment date is 18, because the increment type is linear and therefore the quota's proportion is 10%. A description of the setting of the interruption interpretation quota is provided below along with a description of the screen.

When the total of the respective remaining interpretation availability counts of all the interpretation doctors on the assignment dates at the time of the processing is greater than the interruption interpretation quota (YES in Step S3305), the remote interpretation server 101 determines that there is no available quota for interpretation on the assignment dates even if the interruption interpretation quota is taken into consideration, and the process advances to Step S615. On the other hand, when the total is not greater than the interruption interpretation quota (NO in Step S3305), the remote interpretation server 101 determines that assignment is still possible on the assignment dates, and the process advances to Step S613.

In Step S614, the remote interpretation server 101 determines whether or not the number of the assignment candidate interpretation doctors on the assignment dates is not 0, and when it is not 0 (YES in Step S614), the process advances to Step S3306. In Step S3306, the remote interpretation server 101 determines, as the assignment conditions for the automated assignment, whether or not the dividing of similar requests is prohibited, and similar requests are included in the request to be subjected to assignment. When these conditions are satisfied (YES in Step S3306), the remote interpretation server 101 determines that it is necessary to assign requests including the similar request, and the process advances to Step S3307. On the other hand, as the assignment conditions for the automated assignment, when the dividing of similar requests is permitted, or when the dividing of similar requests is prohibited, but similar requests are not included in the request to be subjected to assignment (NO in Step S3307), the remote interpretation server 101 determines that it is unnecessary to assign the similar request. Then, the process advances to Step S616.

In Step S3307, the remote interpretation server 101 determines, with respect to every assignment candidate interpretation doctor on the assignment dates, whether or not it is possible to assign all of the requests to be assigned and their similar requests, and makes provisional assignment to the assignment candidate interpretation doctors to whom all of the requests can be assigned. Then, the remote interpretation server 101 eliminates, from the assignment candidate interpretation doctors, interpretation doctors other than the assignment candidate interpretation doctors to whom all of the requests to be assigned and their similar requests can be assigned. In other words, the remote interpretation server 101 specifies the total number of the requests to be assigned and their similar requests, and extracts interpretation doctors having an interpretation availability count that is equal to or greater than the total number on the assignment date. Furthermore, the remote interpretation server 101 calculates the remaining interpretation availability score of the interpretation doctor and the total of the scores of the requests specified to be assigned and the scores of their similar requests in Step S613 by the calculation method described above. Then, the remote interpretation server 101 further specifies, from among the extracted interpretation doctors, interpretation doctors having a remaining interpretation availability score that is equal to or greater than the total score. The interpretation doctors thus specified are the assignment candidate interpretation doctors who can manage all of the requests to be assigned and their similar requests. The other interpretation doctors are eliminated from the assignment candidate interpretation doctors. Then, the process advances to Step S616.

After Step S616, in Step S3308, the remote interpretation server 101 sets one interpretation doctor having the highest assignment adequacy degree to the assignment information of the requests to be assigned, based on the assignment adequacy degree of each assignment candidate interpretation doctor calculated in Step S616. When there are a plurality of interpretation doctors having the highest assignment adequacy degree, the remote interpretation server 101 may set one interpretation doctor having the smallest interpretation doctor ID to the assignment information as the interpretation doctor to whom the requests are assigned. Also, when there are similar requests to the requests to be assigned, the remote interpretation server 101 sets one interpretation doctor having the highest assignment adequacy degree with respect to the original requests to be assigned, to the assignment information of the similar requests. In order to avoid duplicated assignment, the similar requests assigned in Step S3308 are eliminated from the requests to be subsequently assigned.

In Step S3309, with respect to the interpretation doctor as the assignee, which is set in Step S3308, the remote interpretation server 101 subtracts one from the remaining interpretation availability count on the assignment date of the assignment schedule. Furthermore, the remote interpretation server 101 subtracts the score corresponding to the request to be assigned, from the remaining interpretation availability score. Note that when there are similar requests to the request to be assigned, the remote interpretation server 101 subtracts the total number of the similar requests from the remaining interpretation availability count, and furthermore, subtracts the total score of the similar requests from the remaining interpretation availability score. Then, the process advances to Step S620.

Examples of Screen Configuration

FIG. 34 shows an example of the configuration of the request assignment condition input screen 3400 to be displayed on the display of the operation terminal 112 when a user of the interpretation center assigns a request information set to an interpretation doctor. The request assignment condition input screen 3400 is displayed when, for example, the automated assignment button 1504 on the request assignment screen 1500 shown in FIG. 15 is pressed. When the assignment start button 3409 is pressed, automated assignment is executed with respect to the request information sets selected with the assignee selection check box 1502 on the request information list 1501 of the request assignment screen 1500 shown in FIG. 15. Then, the results of the assignment (FIG. 16) are displayed.

The similar request dividing 3401 is an item for determining whether to permit or prohibit dividing of similar requests and assigning them to interpretation doctors. When it is prohibited, similar requests cannot be divided, and cannot be assigned to different interpretation doctors. The setting items 3402 to 3405 as similarity conditions are used for setting the conditions for determining the similarity among the request information sets. The interpretation requests are classified into groups according to the conditions that are set here. For example, when the setting item 3402 has a tick mark, the request information sets for the same patient are treated to be similar. Although cases of the same patient, the same examination type, the same examination date, and the same request date are shown here as examples of the similarity conditions, the conditions are not limited to these. In other words, any attribute in the attribute information set of each interpretation request may be used as the attribute for classification, and in addition to the above, the case of a same requestor (person or facility) may be selectable.

The interruption interpretation quota 3406 is the item for setting whether or not to take into consideration the interruption when assigning the requests. The quota's proportion 3407 is enabled when “consider” is selected for the interruption interpretation quota 3406. The quota's proportion 3407 provides options for the percentage (proportion) serving as the reference for calculating the interruption interpretation quota, based on the total interpretation availability count. It is possible to employ a configuration with which the user can select the proportion of the quota from values defined in advance, or the user can freely input a value. Regarding the increment type 3408, the interruption interpretation quota is increased every time the assignment date increases by 1 day, and this item is used for specifying the increase rate. Although “linear”, “exponential”, or the like may be provided as the options for the increment type, the increment type is not limited to them. When “linear” is selected for example, it indicates that the value of the quota's proportion 3407 increases linearly. Specifically, when “5%” is set as the quota's proportion, the proportion calculated for the first day, the second day, the third day, etc. will be 5%, 10%, 15%, etc.

Examples of Configurations of Tables

FIG. 35 is an example of the configuration of the facility information table for interruption 3500 stored in the database 108. The facility information table for interruption 3500 includes requestor facility IDs 3501 and interruption-considering ordinal numbers 3502. The facility information table for interruption 3500 is used for giving priority, for each facility, to request information sets to be preferentially assigned when interruption is considered in the assignment conditions for the automated assignment.

According to the present embodiment, interruption is considered for the automated assignment, and a portion of the interpretation availability count is left unused for the assignment. It is possible that, when a new request information set with a high degree of urgency is received after the assignment, the user can manually assign the request information set with a high degree of urgency to an interpretation doctor by using the unused portion as well. Alternatively, the remote interpretation server may execute the automated assignment again, and assign the request information set with a high degree of urgency to an interpretation doctor by using the unused portion as well, while retaining the already-assigned request information sets.

In the case where the remote interpretation server automatically assigns the request information set with a high degree of urgency, the remote interpretation server may execute the automated assignment at the timing of receiving the request information set with a high degree of urgency. Alternatively, the reception of a request information set may be periodically monitored, and the automated assignment may be performed when a request information set has been received. Also, when a request information set with a high degree of urgency is assigned, the remote interpretation server may provide a notification to the interpretation doctor as the assignee.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-158227, filed Aug. 1, 2014, and Japanese Patent Application No. 2015-089750, filed Apr. 24, 2015, which are hereby incorporated by reference herein in their entirety.

What is claimed is:

1. An interpretation request management system for managing interpretation requests for interpreting medical image data sets, comprising:
a management unit configured to manage the interpretation requests together with attribute information sets indicating attributes of medical image data sets;
a receiving unit configured to receive parameters corresponding to a plurality of interpretation doctors with respect to each of the attribute information sets, the parameters indicating degrees used for determining assignees to which the interpretation requests are assigned; and
an assignee determination unit configured to determine an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors.

2. The interpretation request management system according to claim 1, further comprising a storing unit configured to store an interpretation availability count for each of the plurality of interpretation doctors,
wherein the assignee determination unit determines an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors, and also on the interpretation availability count of each of the plurality of interpretation doctors stored in the storing unit.

3. The interpretation request management system according to claim 2,
wherein the assignee determination unit determines an interpretation doctor to be assigned an interpretation request having an attribute indicated by a corresponding attribute information set, based also on a count obtained by subtracting an interruption count from the interpretation availability count, the interruption count being used for accepting an interrupting interpretation request.

4. The interpretation request management system according to claim 1, further comprising a storing unit configured to store an interpretation availability score for each of the plurality of interpretation doctors,
wherein the assignee determination unit determines an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors, and also on the interpretation availability score of each of the plurality of interpretation doctors stored in the storing unit.

5. The interpretation request management system according to claim 4,
wherein the assignee determination unit determines an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors, and also on the interpretation availability score of each of the plurality of interpretation doctors stored in the storing unit, by making a comparison with an interpretation request score of the interpretation request, the interpretation doctor determined to be the assignee having an interpretation availability score satisfying a predetermined condition.

6. The interpretation request management system according to claim 5,
wherein the interpretation request score is a score determined based on an attribute information set of an interpretation image data set corresponding to an interpretation request.

7. The interpretation request management system according to claim 5,
wherein each interpretation request score is a score determined based on the number of interpretation image data sets corresponding to an interpretation request.

8. The interpretation request management system according to claim 1, further comprising a storing unit configured to store an interpretation availability count for each of the plurality of interpretation doctors and an interpretation availability score for each of the plurality of interpretation doctors,
wherein the assignee determination unit determines an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors, and also on the interpretation availability count of each of the plurality of interpretation doctors stored in the storing unit and the interpretation availability score of each of the plurality of interpretation doctors stored in the storing unit.

9. The interpretation request management system according to claim 1,
wherein each attribute information set includes an attribute of an examination type and an attribute of an examined body part, with respect to a medical image data set corresponding to an interpretation request.

10. A method for controlling an interpretation request management system for managing interpretation requests for interpreting medical image data sets, comprising:
a management step of managing the interpretation requests together with attribute information sets indicating attributes of medical image data sets;
a receiving step of receiving parameters corresponding to a plurality of interpretation doctors, with respect to each of the attribute information sets, the parameters indicating degrees used for determining assignees to which the interpretation requests are assigned; and
an assignee determination step of determining an interpretation doctor to be assigned an interpretation request having an attribute indicated by a corresponding attribute information set, based on the degrees indicated by the parameters that are received in the receiving step, that correspond to the attribute information sets of the interpretation requests managed in the management step, and that correspond to the plurality of interpretation doctors.

11. A non-transitory computer-readable medium storing therein a program to be executed by an interpretation request management system for managing interpretation requests for interpreting medical image data sets, the program causing the interpretation request management system to function as:
a management unit configured to manage the interpretation requests together with attribute information sets indicating attributes of medical image data sets;
a receiving unit configured to receive parameters corresponding to a plurality of interpretation doctors, with respect to each of the attribute information sets, the parameters indicating degrees used for determining assignees to which the interpretation requests are assigned; and
an assignee determination unit configured to determine an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors.

12. An interpretation request management apparatus for managing interpretation requests for interpreting medical image data sets, comprising:
a management unit configured to manage the interpretation requests together with attribute information sets indicating attributes of medical image data sets;
a receiving unit configured to receive parameters corresponding to a plurality of interpretation doctors, with respect to each of the attribute information sets, the parameters indicating degrees used for determining assignees to which the interpretation requests are assigned; and
an assignee determination unit configured to determine an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors.

13. A method for controlling an interpretation request management apparatus for managing interpretation requests for interpreting medical image data sets, comprising:
a management step of managing the interpretation requests together with attribute information sets indicating attributes of medical image data sets;
a receiving step of receiving parameters corresponding to a plurality of interpretation doctors, with respect to each of the attribute information sets, the parameters indicating degrees used for determining assignees to which the interpretation requests are assigned; and
an assignee determination step of determining an interpretation doctor to be assigned an interpretation request having an attribute indicated by a corresponding attribute information set, based on the degrees indicated by the parameters that are received in the receiving step, that correspond to the attribute information sets of the interpretation requests managed in the management step, and that correspond to the plurality of interpretation doctors.

14. A non-transitory computer-readable medium storing therein a program to be executed by an interpretation request management apparatus for managing interpretation requests for interpreting medical image data sets, the program causing the interpretation request management apparatus to function as:
a management unit configured to manage the interpretation requests together with attribute information sets indicating attributes of medical image data sets;
a receiving unit configured to receive parameters corresponding to a plurality of interpretation doctors, with respect to each of the attribute information sets, the parameters indicating degrees used for determining assignees to which the interpretation requests are assigned; and
an assignee determination unit configured to determine an interpretation doctor to be assigned an interpretation request having an attribute indicated by a corresponding attribute information set, based on the degrees indicated by the parameters that are received by the receiving unit, that correspond to the attribute information sets of the interpretation requests managed by the management unit, and that correspond to the plurality of interpretation doctors.
